(19) United States
(12) Patent Application Publication
(10) Pub. No.: US 2025/0356045 A1
(43) Pub. Date: Nov. 20, 2025

(54) SYSTEMS AND METHODS FOR IMPLEMENTING PRIVATE SET INTERSECTION IN DATABASES

(71) Applicant: MongoDB, Inc., New York, NY (US)

(72) Inventors: Archita Agarwal, Secaucus, NJ (US); David Cash, Chicago, IL (US); Marilyn George, Brooklyn, NY (US); Seny Kamara, New York, NY (US); Tarik Moataz, Brooklyn, NY (US); Jaspal Singh, West Lafayatte, IN (US)

(21) Appl. No.: 19/208,892

(22) Filed: May 15, 2025

Related U.S. Application Data
(60) Provisional application No. 63/648,372, filed on May 16, 2024.

(51) Int. Cl. G06F 21/62; G06F 16/2455; H04L 9/06

(52) U.S. Cl. CPC G06F 21/6227; G06F 16/24558; H04L 9/0631

(57) ABSTRACT

Provided are systems and methods for implementing an updatable private set intersection (UPSI) that supports arbitrary deletions, where one is not known to date. Various embodiments leverage this new UPSI to enable and improve a variety of privacy-preserving applications where PSI is currently employed. For example, various embodiments provide a constant round protocol with worst-case communication and computation complexity that grows linearly in the size of the updates and only poly-logarithmically with the size of the accumulated sets, and provides the first implementation to support arbitrary inserts and deletes for updatable PSI. Any one of these functionalities improve over current solutions.

### RELATED APPLICATIONS

This Application claims the benefit under 35 U.S.C. § 119(e) of U.S. Provisional Application Ser. No. 63/648,372, filed May 16, 2024, and entitled “SYSTEMS AND METHODS FOR IMPLEMENTING PRIVATE SET INTERSECTION IN DATABASES,” which is hereby incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A private set intersection (PSI) protocol allows two parties with input sets A and B respectively, to learn the intersection A∩B, while hiding each input set from the other party. Efficient custom protocols have been developed for two party PSI based on public-key primitives, oblivious transfer extension and vector oblivious linear evaluation, where both the communication and the computation complexity of the protocol scales linearly or almost linearly with the size of the input sets. Protocols for PSI and related private set operations have been used in a number of privacy-preserving applications, including online advertisement, contact discovery, and public-key authentication for SSH.

For a number of applications of PSI including online advertisement and password breach monitoring, the set intersection is computed multiple times as the sets grow or shrink over time. This notion of Updatable PSI (UPSI) was first formalized by Badrinarayanan et al., The authors proposed two protocols based on the Decisional Diffie-Hellman (DDH) assumption, where the complexity of successive PSI computations is linearly dependent on just the size of the updates and not the size of the entire input sets. Their first protocol only supports inserts, and the second protocol supports inserts along with a weak notion of deletes—inserted elements can only be deleted after a certain number of epochs.

### SUMMARY

The inventors have realized that there is still a need for a protocol for updatable PSI that supports arbitrary deletions (where one is not known to date); and would be a valuable tool for a number of privacy-preserving applications where PSI is currently employed. Consider for example, the application of measuring online advertisement statistics. In this setting, there are two parties: an online ad agency that provides a platform where users can interact with an ad, and the merchant placing that ad, who is interested in learning how effective their online ad campaign is over a period of time. This computation usually involves some statistics (including some function of the set intersection) over the user data of both the ad agency and the merchant, for users who interacted with the ad and those that made a purchase at the merchant store respectively. To compute these aggregate statistics repeatedly over a period of time while staying in compliance with privacy laws (like GDPR and CCPA), both the ad agency and the merchant must be able to update their user data, including inserting or deleting user records. Hence, a key building block for such a privacy-preserving application would be an efficient protocol for computing private set intersection and related functionalities (like union or cardinality of the intersection) with the ability to update sets arbitrarily over time. This leads to the following natural question, which various embodiments are implemented to answer in the affirmative: are there designs for an updatable PSI protocols that support arbitrary insertions and deletions in constant rounds and with communication and computation complexity that is sublinear in the size of the accumulated sets and linear in the size of the updates?Various embodiments provide a constant round protocol with worst-case communication and computation complexity that grows linearly in the size of the updates and only poly-logarithmically with the size of the accumulated sets, and provides the first implementation to support arbitrary inserts and deletes for updatable PSI.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIGS. 1-2A-B illustrate examples of protocols and definitions to implement private encryption schemes;

FIGS. 3-14 illustrate examples of protocols and definitions to implement private encryption schemes;

FIG. 15 is a block diagram of an example computer system improved by implementation of the functions, operations, and/or architectures described herein; and

FIGS. 16-22A-B illustrate examples of protocols and definitions to implement private encryption schemes.

### DETAILED DESCRIPTION

Many conventional custom protocols have been developed for two-party private set intersection (PSI), that allow the parties to learn the intersection of their private sets. However, these approaches do not yield efficient solutions in the dynamic setting when the parties' sets evolve, and the intersection has to be computed repeatedly. Described are systems and methods for a new framework for this problem of updatable PSI with elements being inserted and deleted in the semi-honest model based on structured encryption. Various example constructions executed in a constant round protocol with worst-case communication and computation complexity that grows linearly in the size of the updates and only poly-logarithmically with the size of the accumulated sets. Various embodiments provide the first protocol to support arbitrary inserts and deletes for updatable PSI. The framework and embodiments reduce the problem of updatable PSI to a new variant of structured encryption (StE) for an updatable set datatype, which also forms a basis for independent interest. In some examples, a dynamic structured encryption primitive is implemented that enables a client to create, query, and update an encrypted data structure stored on an untrusted server.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The following description explains principles and examples for the construction of an updatable PSI protocol, where either party can insert or delete elements. Various approaches are configured to scale with the sizes of the parties' updates, and only poly-logarithmically with the size of their accumulated sets. Implementation stems from a general framework that builds updatable PSI (with arbitrary deletions) generically from a flavor of dynamic structured encryption (StE) for set membership queries.

### Example Framework for Updatable PSI

At a high level, the framework for updatable PSI updates and improves on the ideas of Badrinarayanan et al., Each party holds an encrypted data structure that represents the other party's current_set. Examples of the protocol start with each party updating that representation to insert and delete elements from the encrypted data structure, followed by invocations of the StE query protocol and a generic private set union (PSU) protocol that reveal the new set intersection. The description also formalizes the exact leakage of the updatable PSI protocol in terms of the leakage of the underlying primitives StE and PSU.

For example, in implementing various embodiments the approach must confront two difficulties, one definitional and the other algorithmic: First, the notion of security described is difficult to capture with standard 2pc definitions. Second, the needed StE does not exist, and there are technical challenges in realizing it while maintaining minimal leakage in the updatable PSI framework, where only the size of the update sets is leaked in each epoch to both the parties. Various considerations are elaborated on these challenges in the following subsection.

### Example Dynamic StE for Updatable Sets

In addition to the framework, additional technical contributions are found in the designs of a dynamic StE scheme ESX that can be used with the framework and may be of independent interest. In one example, ESX supports an updatable set datatype, where a client can add and delete elements and perform membership queries over the updatable set. In various constructions, the scheme leaks the query equality for membership queries, but has minimal leakage for updates. Its protocols are constant round, and it scales poly-logarithmically with the size of the set. As discussed below, this requires new insights for ORAM-like data structures that can change size over time.

Example Dynamic StE with Server-Side Querying

Various embodiments provide a dynamic StE in various frameworks for updatable PSI, based on the system including the novel functionality of server-side querying instead of traditional StE client-side querying. In particular, the party holding the encrypted set structure (representing the other party's updatable set) is able to execute membership queries over the encrypted set. Various embodiments improve encryption schemes (e.g., ESX) to support server-side querying with similar asymptotic complexity and minimal leakage for both updates and query. The inventors have realized that server-side querying has not been considered in the prior StE literature.

### Example Updatable PSI: Instantiating the Framework

Various embodiments include a construction of ESX with server-side querying that can be instantiated with an OPRF protocol and a generic 2pc protocol (e.g., like garbled circuits). Such constructions, along with a PSU protocol can be used to instantiate the framework; resulting in an updatable PSI protocol that supports arbitrary inserts and deletes with minimal leakage—i.e., the protocol leaks nothing but the size of the update sets in each epoch. Further, for each epoch, embodiments of the protocol take constant rounds, and have worst-case communication and computation complexity that scales linearly with the size of the update set up to poly-logarithmic factors.

### Example Technical Considerations

2pc with Leakage

A typical definition of 2pc security requires, informally, that “nothing is revealed to either party, beyond what they can compute from their own input and output”. The precise meaning of this security guarantee can be hard to interpret. Specifically, when a 2pc protocol (and its target functionality) assume that inputs are of a certain size, or fit a given format, then arguably this information is being “revealed”. For example, conventional approaches assume that each party wishes to add a fixed number of elements in each epoch, or is willing to pad their additions up to that fixed number. In practice larger additions would require multiple runs of a protocol, effectively leaking some information on the size of the updates.

To facilitate understanding the discussion uses a generalized view of 2pc, which allows for functionalities that accept inputs of any size or type. As a result, embodiments allow explicit leakage that is given to the simulator, in order to express the information revealed about the size and type of the inputs. In particular, in the case of an updatable PSI protocol, the functionality allows sets of any size to be input, and the corresponding leakage explicitly states the information that can be revealed to the parties, enabling accurate description of the security of the protocols. In some examples, this definitional approach also results in our minimal leakage being the size of the updates during the protocol. An alternative would be to assume that the functionality only accepts updates of a fixed size known to both parties.

Various embodiments also include some downsides, like added complexity (especially to composition), but such approaches can be used for giving security theorems that more closely match applications.

### Example Dynamic StE: Growing and Shrinking Trees.

To highlight some of the novel features, provided is an example of an StE version, where the client inputs both the updates and queries. The construction utilizes an “ORAM-like” tree with log-size buckets but without a recursive position map. Querying for elements of the sets simply involves evaluating a PRF to determine a path, requesting that path from the server and checking it for the relevant element. Hence, querying the same element fetches the same path from the tree leaking query equality to the server, unlike a typical tree ORAM. In execution, updates are more technically involved. A challenge is that the underlying set is growing and shrinking, while updates (adds or deletes) and queries should not reveal information about each other. To unlink updates and queries, various embodiments use the ORAM approach of adding elements to the root of the tree and letting oblivious evictions eventually move them down the tree. Further, some embodiments perform deletions lazily, meaning that to delete an element x, add a flag indicating that x should be deleted. In actual example constructions, the system adds x again to delete it. At query time, the system checks if x appears an even or odd number of times and determines if it is still in the set. Since both adds and deletes are now essentially the same, lazy deletion also helps reduce the leakage of the resulting construction.

While deletes temporarily consume more space, deletes will eventually be cleaned up during evictions. Various implementations provide technical novelty in the management of the size of the tree with minimal leakage. As data is added and deleted, the system gradually adds and deletes leaves of the tree to change its overall capacity. This is a delicate process because of how it interacts with lazy deletions: Since those deletions consume more space temporarily, it is not the size of the set, but the number of “slots” used in the tree that should determine the capacity. This number can vary depending on how many deletes are cleaned up during evictions. However, the decision to grow or shrink the tree is visible to the server, and a naive approach to making this decision results in unintended leakage. For example, if evictions opportunistically lower the size of the tree early and cause us to start deleting leaves, then the server can infer that it is more likely to be adding and deleting the same element multiple times. Various embodiments resolve this by growing and shrinking based on leaked information, namely only the total number of adds and deletes (but not what was added and deleted).

Further embodiments upgrade this client-side querying StE with query equality leakage to an StE with server-side querying and no leakage beyond the size of the update and query sets using any generic secure 2pc protocol and any oblivious PRF protocol. The system can use this final StE to build our updatable PSI protocol with minimal leakage. The inventors have realized that the resulting updatable PSI protocol has minimal leakage even when the underlying StE has query equality leakage. This observation allows use of a non-recursive ORAM-like tree to build a constant round updatable PSI protocol with asymptotic complexity that scales linearly in size of updates and only poly-logarithmically in size of the accumulated sets.

### Conventional Work and Example Improvements

### Conventional PSI

Over the last decade, the design of two-party and multi-party PSI protocols has been an active area of research, where the focus has been on developing concretely efficient solutions for different network settings and practical set sizes. There are quite a few protocol paradigms for PSI, including circuit-based, key agreement, oblivious transfer extension and vector OLE to name a few. Most of these conventional protocols have computation and communication complexity that scale linearly with the size of the input sets. Also note that these constructions leak the size of both input sets, along with the expected output.

### Sublinear Communication PSI

In the case where the input sets have asymmetric sizes, it is possible to construct two-party PSI solutions where the communication scales with the size of the smaller set. These solutions include those based on RSA accumulators, pairing based accumulators, leveled fully homomorphic encryption and Computational Diffie-Hellman. All these protocols use expensive cryptographic operations (public-key operations), and they have linear computation overhead in the size of the larger set—making them not suitable for the updatable setting even when considering asymmetric set sizes.

For the asymmetric case, a number of works have also designed PSI solutions in the offline-online model, where in the offline phase the parties do some pre-processing given as input to the larger set. In these constructions the online phase has computation and communication complexity that scales linearly with the size of the smaller set. However, these solutions have not been explored in the updatable setting with one exception. Kiss et al. extend their offline-online PSI framework to support insert and delete updates as well. However, their protocol has leakage beyond the size of the input and update sets. Particularly, when an element is output from their PSI protocol, both parties learn in which epoch the same element was previously inserted in the other party's set. In the updatable PSI framework discussed herein, embodiments avoid this ‘historical’ leakage using the novel StE construction, while paying a poly-logarithmic overhead in complexity.

Another direction in PSI is to consider settings where one party's input set has a publicly known structure, allowing for more efficient PSI solutions where the communication scales with the description size of the structured set instead of its cardinality. This construction is based on OT and function secret sharing (FSS), and incurs a computation overhead linear in the cardinality of the structured set. These solutions are only known for special types of structured sets (like union of constant radius f-infinity balls), and they are not comparable or usable in the context of the updatable PSI solution for arbitrary sets discussed herein.

Private Set Operations with Updates

The reactive functionality of updatable PSI was first formulated by Badrinarayanan et al. They developed two solutions based on the DDH assumption for updatable PSI, one that supports arbitrary inserts, and one for arbitrary inserts along with “weak deletion”. Here weak deletion implies that elements inserted before the latest t epochs are deleted (where t is a parameter). Their constructions only leak the size of the update sets in each epoch, unlike the updatable PSI construction due to Kiss et al. Their solutions are also asymptotically optimal—with their communication and computation scaling linearly with the size of the update sets. However, the new framework for updatable PSI discussed herein improves on such approaches by allowing for arbitrary deletes and inserts in each epoch, and improvements on efficiency—at the cost of a poly-logarithmic overhead in computation and communication complexity. The discussed complexities are also provided as worst-case, whereas computation costs are actually amortized over a larger number of epochs for weak deletions.

Dittmer et al. studied a weighted variant of asymmetric and updatable PSI in which the output is the sum of the weights of keywords in the inter section. Their approach avoids expensive public key cryptography, and instead uses symmetric key based FSS for point functions as the key building block. The communication complexity of each update and weighted-sum PSI computation scales linearly with the size of the updates, however the computation complexity of their protocol still scales with the size of the entire set. Their work is also limited to the three-party setting, where the client inputs the smaller set, and the larger input set is available with two non-colluding servers—making their model incompatible and unsuitable to the discussed approaches herein.

### Oblivious RAM.

ORAM allows a client to hide its data access patterns from an untrusted server that it uses for outsourcing data. This notion was first introduced by Goldreich and Ostrovsky, but since then it has been heavily optimized for a number of applications. These constructions support fixed array size, and hence they cannot be directly used in designs or embodiments of the discussed StE construction—which is dynamic, and which has worst case poly-logarithmic cost for an update or query.

The only known resizable tree-based ORAM construction is due to Moataz et al. However, this construction along with other tree-based ORAM constructions have logarithmic round complexity due to the need for recursively storing the position map in a smaller ORAM. Various embodiments of the StE construction improve over other such approaches, for example, avoiding the need for a position map altogether, and further enabling query and update protocols in constant rounds.

### Example Basic Terminology and Notation.

For ease of reproduction, in the discussion, scripted characters/variables and notation is denoted in times new roman format (drawings and appendixes include scripted formats but may also be referenced by scripted characters). The description will reference the following concepts and terminology: efficient means probabilistic polynomial-time (in the input size). A security parameter will be denoted k. Denote the empty string as F. The symbol II denotes string concatenation. For a randomized algorithm A, write y←A(x) to denote running A on input x and letting y be a random variable representing its output.

### Basic Primitives

Use CPA-secure symmetric encryption, pseudorandom functions (PRFs), and collision-resistant hash functions. Where theorems do not depend on the finer details of the definitions, they are omitted. Knowledge of conventional definitions is assumed (including e.g., Katz and Lindell).

### Example Two-Party Computation Definitions

Treatment of two-party protocols in this description is agnostic to details of how they are formally defined. Description considers stateful protocols where both parties accept inputs as well as some (possibly empty) previous state, and emit local outputs and some updated state. (This state refers to information saved between runs of the protocol, and not the information privately held by the parties during a run of the protocol.) When Π is a stateful two-party protocol, write

$$( {out}_{1} , {st}_{1} ; {out}_{2} , {st}_{2} \vert {V}_{1} , {V}_{2} ) ← \prod ( {in}_{1} , {st}_{1} ; {in}_{2} , {st}_{2} )$$

to denote running II where party i gets input inᵢ and state input st₁, and emits output outᵢ and an updated state, and has view Vᵢ(consisting of its random tape and all incoming messages). Description considers stateless (i.e., one-time) protocols, where embodiments omit the state inputs and outputs. When not relevant, the description omits the V₁, V₂ outputs from the notation.

A (deterministic) two party reactive functionality is, formally, any function F: ({0, 1}*∪{⊥})³→({0, 1}*∪{⊥})³. Following emphasis on the full leakage profile of two-party protocols, some embodiments are configured to not allow functionalities to be “partial”; functionalities must be total functions (e.g., must explicitly return errors if their input is not of the expected form). Write the evaluation of a functionality F as (out₁, out₂, st_{F})←F(in₁, in₂, st_{F}); intuitively, the first two inputs to F correspond to the parties' inputs, and the third input the state of the functionality. The functionality outputs the parties' local outputs and an updated state.

Define (non-reactive, deterministic) functionalities to be functions of the form F: ({0, 1}*∪{⊥})²→({0, 1}*∪{⊥})². These can be interpreted similarly to the above definition, except that they do not have state inputs or outputs.

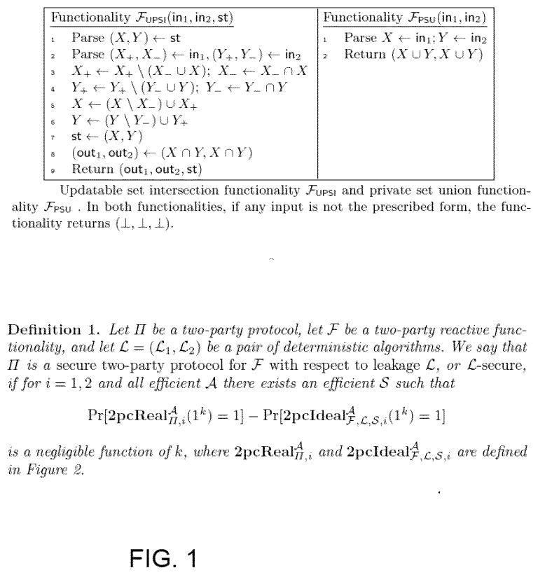

FIG. 1 defines the reactive functionality F_{UPSI} updateable private set intersection and the non-reactive functionality F_{PSU} for private set union. In contrast to prior work, example versions of F_{UPSI} allows for set updates to vary in size, and even be malformed (e.g. deleting an element that is not already present). Similarly, F_{PSU} allows for the sets X, Y to be of any size (though in some examples, when they are chosen by a poly-time adversary, X and Y are written down explicitly, which effectively limits their size when working with the functionality in security definitions). Compared to prior work, these definitions are more general in allowing flexibility for the users, but necessitate modified definitions (discussed below) to be achievable in some cases.

### Security of Two-Party Computation for Reactive Functionalities

The definition 1 (e.g., FIGS. 1,2) captures secure two-party computation of a reactive or non-reactive functionality against a passive, non-adaptive adversary.

The example definition notably departs from standard two-party computation definitions in conventional approaches in that it explicitly models the leakage of a protocol in the style of structured encryption. This appears as a leakage profile L=(L₁, L₂), a pair of algorithms where Lᵢ computes the information required for simulation for party i. Traditionally this leakage is expressed as a “parameter” of a functionality, but our protocols will involve non-trivial leakage that is more properly expressed this way.

In example definitions, the adversary is allowed several invocations of the protocol from the point of view of one party, each of which mutate the state of the parties. For technical reasons, consider a version of this definition where the adversary is allowed to ask for several sequential runs of the protocol with “resets” in between them. In traditional definitions, standard hybrid arguments can show that a single execution is equivalent to several with resets. However, in this setting with leakage profiles, this property does not hold. That is, the disclosure considers that it may be possible that a protocol has some non-trivial leakage that is not noticeable in a single run but shows up as correlations between several runs.

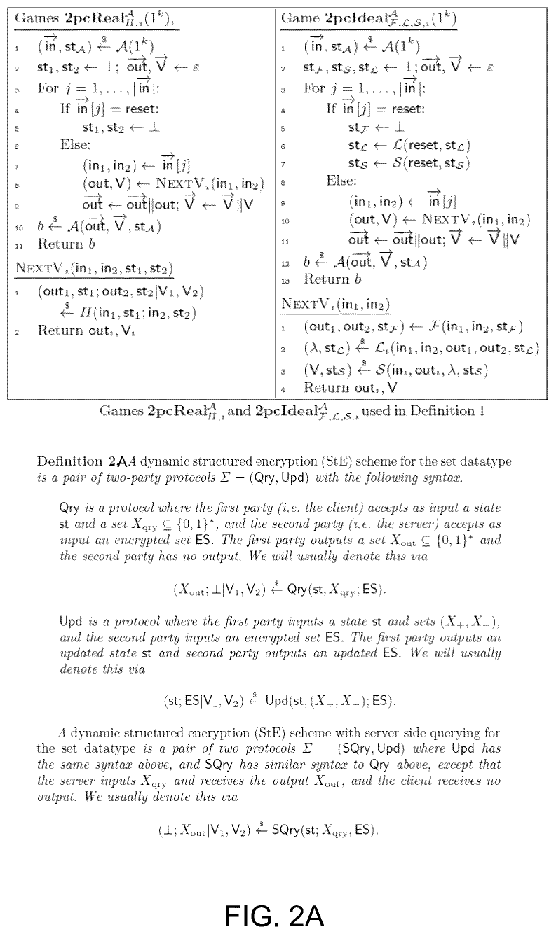

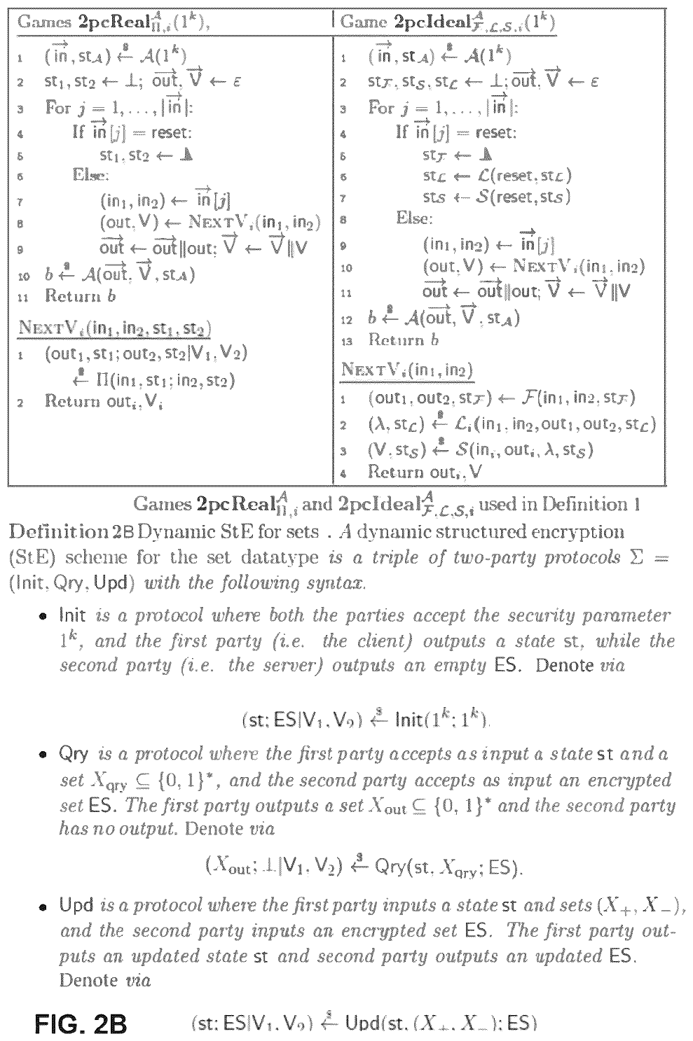

To highlight features of the disclosure, the disclosure explains the meaning of the games (e.g., FIG. 2), starting with 2pcReal_{π,i}^{A}, This game starts with A choosing a sequence \vec{in}, where each entry consists of either a pair of inputs for the parties or a special symbol reset. Intuitively, entries of this vector indicate either that A would like the protocol run on these inputs, or to have the parties' private states set to empty, effectively restarting their interaction from scratch. The game then processes this vector to product \vec{out}, \vec{V} for A. Each such entry is produced by running Π on the chosen inputs, using state st₁, st₂ that are

maintained in the game. When a reset symbol is encountered, the game simply returns st₁, st₂ to their initial empty states. The ideal game 2pcIdeal_{F,L,S,i}^{A} starts by initializing states st_{F}, st_{L}, stₛ.

When A provides \vec{in}, the game produces the individual views by invoking the functionality F, and then the appropriate leakage function (either L₁ or L₂), and finally runs the simulator S on the input and output of the party, and the output λ of the leakage function to produce the view. Each of F, L, S maintains its own state, which are updated on each run. The outputs in \vec{out} are chosen by the functionality and not the simulator. Reset symbols are processed by resetting only the state of the functionality (but not the simulator or leakage profile). The leakage profile and simulator are however notified of a reset on lines 6 and 7, where they are allowed to update their state.

### Simplifications for Stateless F

When F is non-reactive, the definition simplifies considerably. In the real game, omit the states st₁, st₂, as the protocol is “one-shot”. This means that resets become meaningless, and description can assume they are not submitted. In the ideal game, now omit the functionality state st_{F}, but (importantly) keep the leakage and simulator states st_{L}, st₅ so that they can correlate the simulated views, if required. The review can similarly assume that resets are not submitted (as L, S know that there is no state to reset).

On line 1 of NextVᵢ of the ideal game, analysis can omit the out₁, out₂ inputs to L, since it can compute these itself. (With a stateful F this might not be the case, since L does not have access to st_{F}.) Also note that definitions apply a form of correctness in that the adversary can test if the output value it receives is correct according to F.

### Example Reverses of Protocols

Some description takes two-party protocols and swaps the roles of the parties. Examples formally define the reverse of a protocol Π, denoted Π^{T}, to the protocol resulting from switching the roles of the parties (including who speaks first). It is trivial that if Π is a L-secure protocol for F, then its reverse Π^{T} is L^{r} secure for F^{r}, where L^{r} and F^{r} interchange their inputs and outputs from F and L.

### Example Structured Encryption Definitions

The description uses two notions of dynamic structured encryption (StE). Both model a set data structure, where a client can add and delete elements from a set, and then issue (batch) membership queries on the current set. The first notion (Definition 2, FIG. 2) is where the client issues queries. Intuitively, security is only guaranteed for the client, as the server has no private inputs. The description uses this definition for presenting constructions of ESX for standalone purposes.

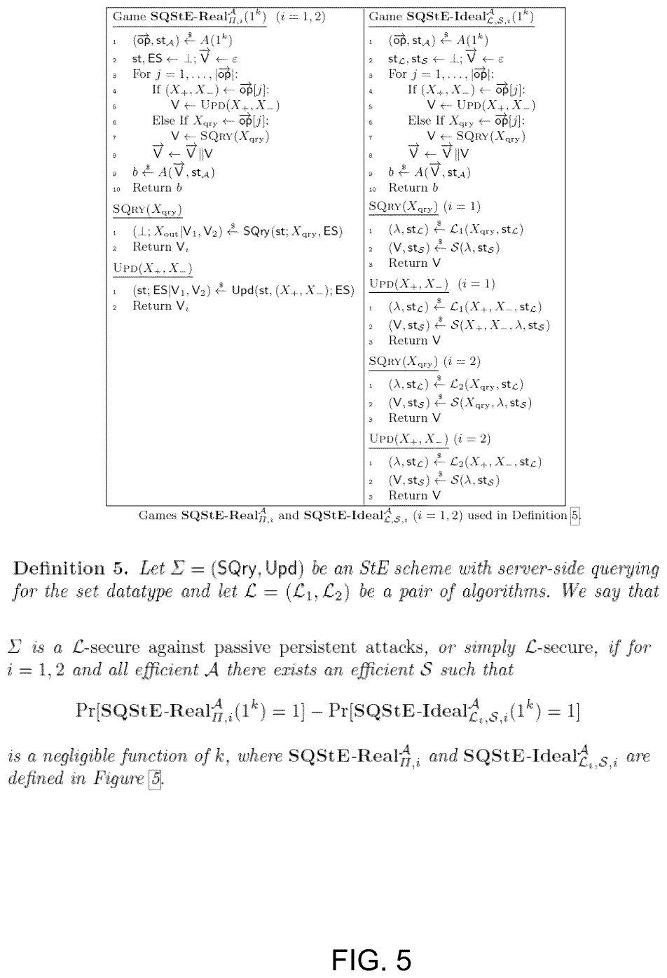

The second notion (Definition 5, FIG. 5) is also novel, and is used in embodiments of the general framework. This notion, which is described as StE with server-side querying, allows the server to make queries instead of the client. The server's input is considered private, so the security definition includes conditions for both parties, in the style of two-party computation. Various approaches construct a standard StE scheme and then modify it (using standard tools) to support server-side querying.

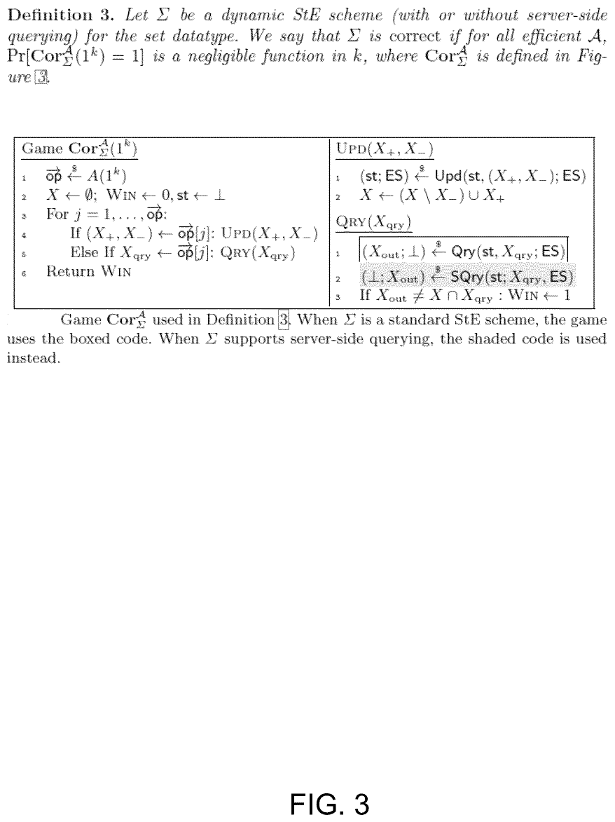

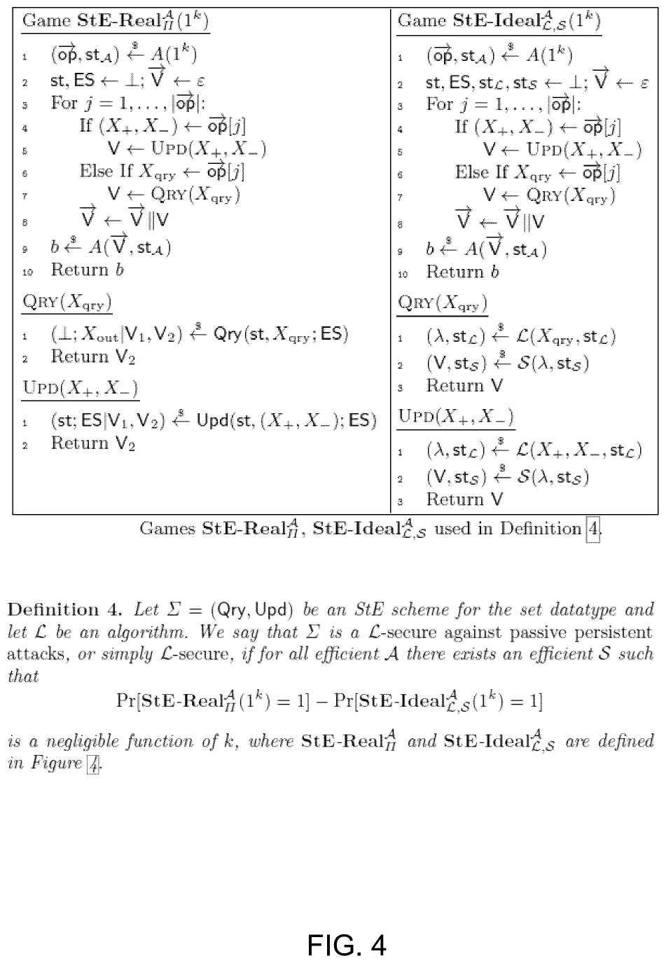

Security and correctness definitions for both types of StE are described with respect to non-adaptive adversaries who declare all of the parties' inputs up-front. This is because the notion of two-party computation targeted for updatable PSI may use these weaker definitions. The next definitions (e.g., definition 2A & 2B, FIGS. 2A-2B, definition 3, FIG. 3, definition 4, FIG. 4) introduce both types of StE. Definition 3, FIG. 3, defines correctness for both types of StE. The analysis does not use a simpler definition (e.g. where answers are correct with probability one) since constructions typically err with negligible (but non-zero) probability, for example when hash collisions occur.

### StE Security

The examples recall a standard non-adaptive real/ideal definition of security of traditional StE (without server-side querying) with respect to a leakage profile L. This definition intuitively includes that whatever is learned by the server is limited to the output λ of L.

Define security for StE with server-side querying as follows: As mentioned above, this includes defining security for both parties, since now updates should be private from the server and queries should be private from the client. The description uses the subscript i=1 to denote security for the server's queries, and i=2 to denote security for the client's updates—see definition 5, FIG. 5.

The following description highlights some details in the ideal game used to define security. In the case i=1, where S is simulating the client's view, S is given inputs X₊, X₋ during updates but is not given X_{qry} during queries. This represents that the client knows its own inputs, but does not know the server queries. Give X₊, X₋ to the leakage profile to allow it to update its state for future leakage computation. In another example, use a similar choice in the i=2 case (i.e. security for the client), where X_{qry} is now given to the simulator during queries, but X₊, X₋ are not given to the simulator during updates.

### Example Implementation: Private Set Union

As an example of a building block in various embodiments, the system provides a non-reactive private set union (PSU) functionality (presented in FIG. 1). The functionality takes as input two sets X, Y from two parties respectively, and it outputs X∪Y to both parties.

Example Embodiments of Updatable PSI from Dynamic Structured Encryption

Various embodiments include a general updatable PSI protocol supporting arbitrary inserts and deletes from any dynamic StE E with server-side querying and any PSU protocol Π_{PSU}. Prove the security of the protocol with respect to a leakage profile that is derived from the underlying leakage profiles of Σ and Π_{PSU}. Emphasize that while the framework is general, the instantiation of the underlying protocols must be done carefully to preserve the overall security and efficiency of the resulting updatable PSI protocol. Various embodiments construct a dynamic StE scheme with server-side querying and use the disclosed framework to construct example an updatable PSI protocol with minimal leakage, i.e., only the size of the updates.

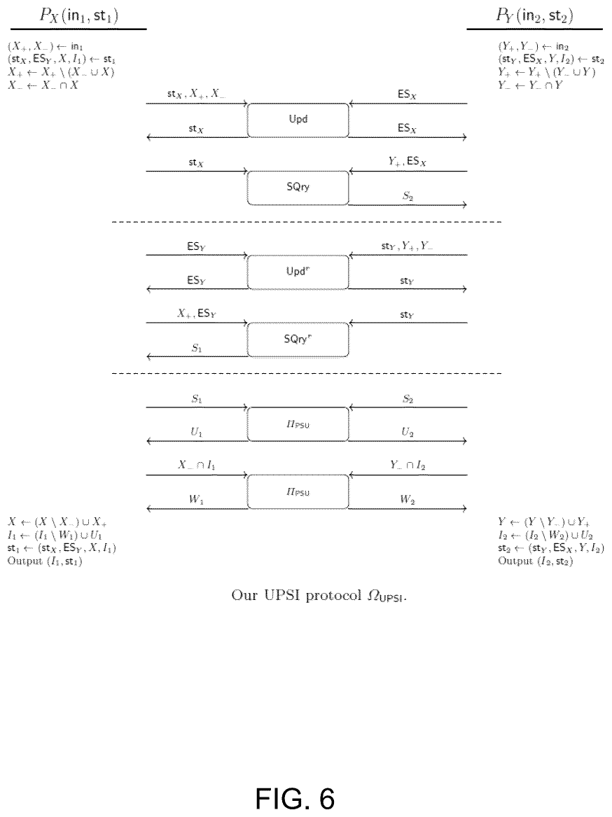

An example framework is presented in FIG. 6. At a high level, each party uses Σ to update their own encrypted set (held by the other party), and to server-side query the other party's set. Both parties use the Π_{PSU} protocol to compute the elements that must be added or removed from the intersection.

Denote the parties P_{X} and P_{Y} with input sets X and Y, and refer to them as the left or the right party, respectively. Assume that each party already holds an encrypted set representing the other party's (previous) set, and that each party knows the intersection of the (previous) sets −denoted as I₁, I₂, where I₁=I₂. In the first epoch of the protocol, these encrypted sets as well as the intersection can be considered empty. The framework now shows how to incorporate each party's inserts and deletes X₊, X₋ and Y₊, Y₋, and compute the updated intersection.

To begin, both parties ensure that their inputs are well-formed (e.g., only deleting elements if they are in the sets). In the first stage of the framework, the left party acts as the client and runs the update protocol from E to perform the updates X₊, X₋ on ES_{X}, held by the right party. The right party then uses the server-side query of Σ to query the updated ES_{X} with its additions Y₊. The second stage is symmetric, with the roles reversed. At the conclusion of the first and second stages the left and right parties receive sets S₁, S₂ respectively, which together consist of the elements that must be added to the intersection. For example, recall that Si consists of elements that the left party added that are present in the updated set of the right party, and vice versa.

Next, the parties run Π_{PSU} on the sets S₁, S₂ to learn their union (expressed as U₁, U₂, where U₁=U₂=S₁ ∪S₂). Next, the parties compute the elements to be removed from the current intersection. These elements are the elements of the previous intersection that were deleted by one or both parties. In order to compute this, the parties run Π_{PSU} with the inputs X₋∩I₁ and Y₋∩I₂. The union of these sets (expressed as W₁, W₂) is removed from the previous intersection. Finally, each party locally updates the previous intersection to compute the updated intersection.

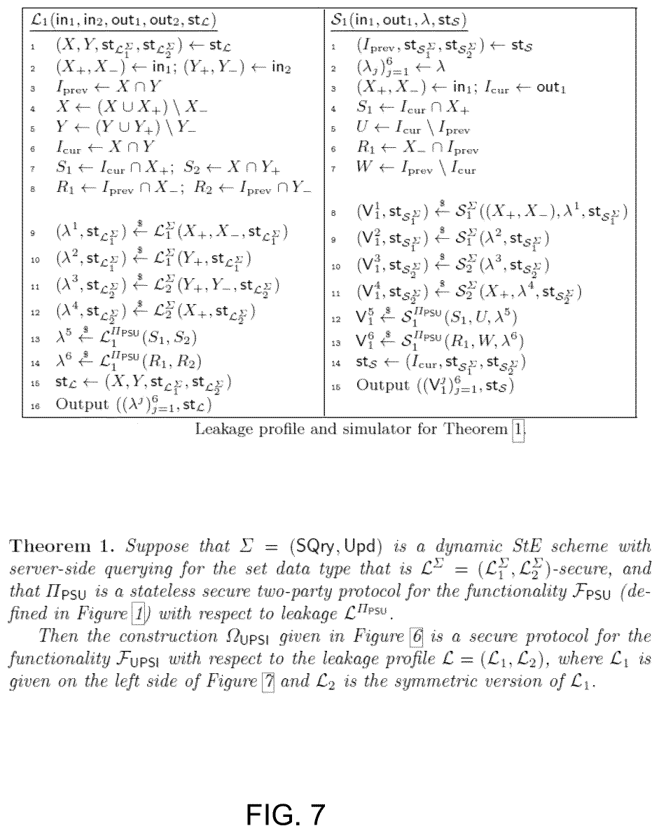

A formal proof of the theorem 1, FIG. 7, can be found in Appendix A. To illustrate some features the discussion explains the resulting leakage profile L₁ (the case of L₂ is symmetric) in example implementation of the framework. Lines 1-8, FIG. 7, represent bookkeeping by the leakage profile to remember the parties' sets X, Y, the new and previous intersection, and the values S₁, S₂ (representing the elements in the new intersection that were newly added by each party) and R₁, R₂ (representing the elements from the previous intersection that were deleted by each party). Lines 9-14 compute the actual leakage. Lines 9 and 10 describe what the left party learns about Y₊, the additions from the right party, which would typically be only |Y₊|. Then lines 11 and 12 describe what this party learns about Y₊, Y₋ during the other party's update and query stage. Once again, this would typically be only |Y₊| and |Y₋|, but could be more or less information depending on the leakage of the underlying scheme E.

Next, lines 13 and 14 compute leakage on the intermediate values. A natural choice, in one example, may be to let the left party learn |S₂| and |R₂|, but this should be done with the awareness that this is non-trivial leakage about the other party's input that is conceivably harmful in applications. Note that this issue can be addressed by assuming that the party's input sets (X₊, Y₊) were bounded by some publicly-known size, and padding smaller sets to this size before running the PSU protocol.

Given the resulting leakage profile, in order to design an updatable PSI protocol with minimal leakage embodiments construct a dynamic StE scheme with server-side querying with minimal leakage as well, where the update and query protocols of the StE scheme leak nothing more than the size of the update/query sets, and such implementation is described in greater detail below.

### Example Dynamic Encrypted Set Construction: ESX

Various embodiments construct an StE scheme for the set datatype that is compatible with the above framework. Embodiments of the system can be constructed by first building a construction “ESX” that supports client-side querying described below. ES_{X} examples are constructed using symmetric-key primitives and having only “query equality” leakage—i.e. the server learns which client queries match across different query calls. For both update and query operations, the construction takes constant rounds, and both parties perform work that is poly-logarithmic in the size of the accumulated set.

Further embodiments illustrate updates and improvements that modify this ESX construction into one that supports server-side querying using: Oblivious PRF and generic two-party computation. Most importantly, the embodiments show that server-side querying StE has minimal leakage while having the same asymptotic complexity as ESX.

### Client-Side Querying Embodiments

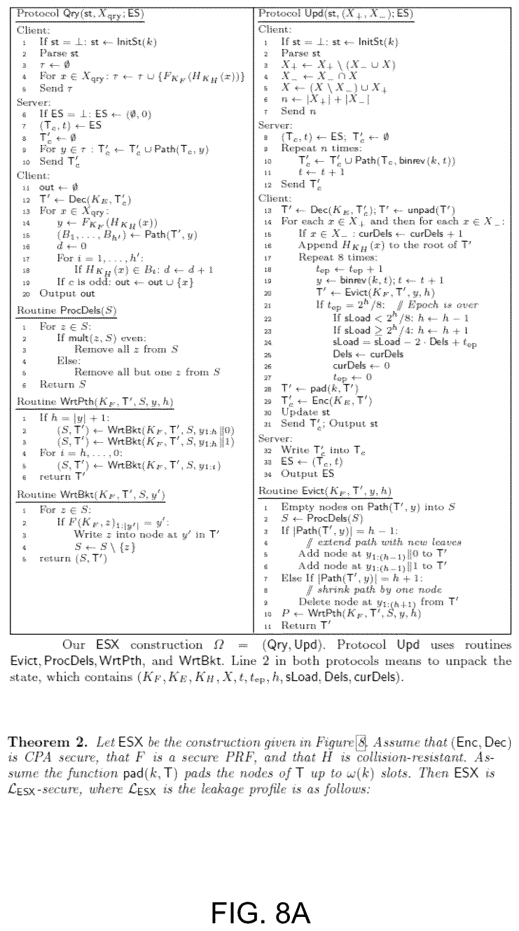

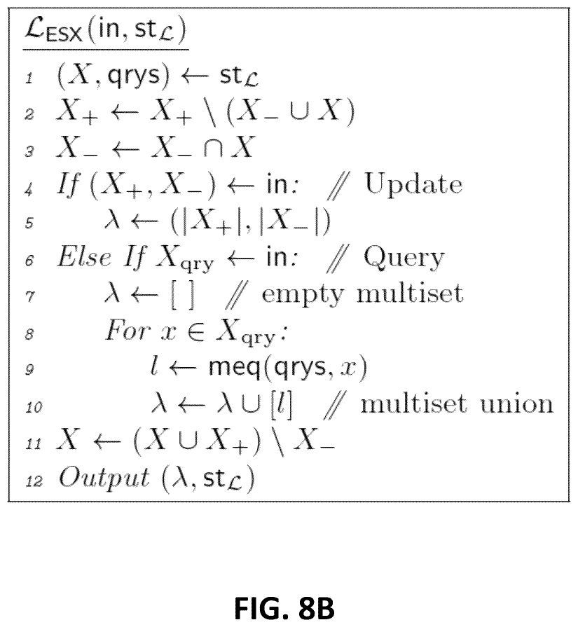

Example constructions of ES_{X} are shown in FIG. 8A which protocols Qry and Upd along with routines Evict, ProcDels, WrtPth, and WrtBkt which are used by Upd.

### Example Notation.

Various protocols are configured to perform operations on binary trees, which are not assumed to be complete. The description implicitly assumes that children of nodes are labeled as left or right. Given a bitstring y ∈{0, 1}*and a tree T, write Path(T, y) for the path that chooses the left or right child at each step according to the bits of y until it reaches a leaf. If y is longer than this path is deep, the remaining bits are ignored. In this path, assume that the children are labeled left or right. Similarly refer to the “node at y” (which may be undefined if y is too long). Unions of paths (such as the union on line 8 of Qry FIG. 8A) construct (non-full) binary trees. Write |Path(T, y)| for the number of nodes on the path Path(T, y).

### ESX Construction Examples: Data Layout

The server is configured to maintain an encrypted binary tree, and each node of the tree holds a bucket of some number of “slots” which may be either real or padding. In some constructions, however, the size of the tree will gradually grow or shrink over time in epochs. Define an “epoch ending” to be when line 21 of Upd FIG. 8A evaluates to true. During one epoch, the tree will either grow a new level (adding two leaves per operation), shrink one level (removing one leaf per operation), or stay the same. Also during an epoch, the size of each bucket can grow, shrink, or stay the same.

The decision to grow the tree and buckets is visible to the server and thus may leak information. It is realized that the system cannot simply track the number of real slots used in the tree and use this count, because whether or not deletions have been cleaned depends on the actual operations. Instead, to limit leakage, the decision to grow or shrink is determined by a simulated load, which is a pessimistic upper bound of the number of non-padding items (representing additions and deletions) in the tree at the end of an epoch. The system is configured to ensure that this upper bound depends only on the number of additions and deletions performed during each update, and can thus be simulated from a leakage profile that provides these.

### ESX Construction Examples: Ingredients

Use a standard CPA-secure encryption scheme (Enc, Dec) with k-bit keys. The following description abuses notation and feeds trees to these algorithms to mean running encryption or decryption on every slot in a tree. Thes description includes use of a variable-input-length PRF F that takes a k-bit key and produces a k-bit output.

Examples of the construction use a routine binrev(k, t) that takes a positive integer k and an integer 0≤t≤2^{k}. It computes the standard k-bit representation of t and reverses it. Finally, examples of the construction use a padding pad(k, T′). On input positive integers k and a (partial) binary tree T1, it pads all of the buckets in T′ with plaintext dummy slots to some fixed size that depends on k. Theorem 2, FIG. 8A, specifies our requirements on this operation.

### ESX Construction Examples: Querying

An example query protocol is given on the left side of FIG. 8A. The client starts by initializing its state if this is the first time it has run: The routine InitSt(k) chooses K_{F}, K_{E}, K_{H}^{S}←{0, 1}^{k}, sets X←Ø, and sets tₑₚ, sLoad, Dels, curDels all to zero. The client takes hashes of each element in its input set X_{qry}, applies the PRF F to the hashes, and sends the set of outputs T to the server. By our assumption on F, the outputs are all k bits long.

Next, for each string y ∈τ the server looks up the path in its tree T_{c} using y. Since y is k bits long, these paths will extend to a leaf of the tree (for sufficiently large values of the security parameter k; since the adversary is polynomial-time in k, the tree can be assumed to have depth at most k). The server forms a subtree T′_{C} of T_{C} as the union of these paths and sends it to the client.

The client computes its output by decrypting the subtree T′_{C} to T′. For each element x of its input, it checks if (the hash of) x is present on its corresponding path an odd number of times, keeping it for the output if it is.

### ESX Construction Examples: Updating

An example update protocol is given on the right side of FIG. 8A, with associated routines given lower in the figure. The client begins the protocol by initializing its state if necessary, and then lines 3-5 ensure that X₊, X₋ have the appropriate form and update the local copy of X. The client then simply tells the server the total number of elements being added and deleted.

The server computes the next n deterministic paths In this tree as determined by its state counter t, and lets T′ be their union and sends it to the client. The client decrypts T′ to Tc and removes the padding slots. Then for each element x to be added or deleted, it appends H_{K}_{_{H}}(x) to the root of T′_{C} and calls eviction on the next deterministic path; and eviction is described in greater detail below.

After eviction, it then checks if the current epoch has ended. The scheme maintains an invariant that at the end of each epoch the server's tree T_{c} is a complete binary tree with 2^{h} leaves at the end of each epoch, and at this point the client decides if the next epoch should add a level to the tree, remove a level, or leave the depth unchanged.

This decision is made according to sLoad, the “simulated load” on the tree, which is updated at the end of each epoch as follows: The client pessimistically assumes that tₑₚ new data items have been added to the tree (i.e. no delete operations were cleaned up), so it adds tₑₚ to sLoad. But the client and the server also knows that the previous epoch's delete operations were cleaned up, so the client subtracts 2 Dels form the simulated load. The client then adjusts h, the new tree height, using the updated sLoad on lines 26-27.

Finally, the client pads the tree T′ using pad(k, T′), which adds extra padding slots to nodes of T′. Here, the nodes may grow or shrink in response to a change in sLoad. The client then encrypts T′ and sends the result to the server, which overwrites the corresponding portion of its encrypted tree (including appending new nodes or deleting nodes, according to the T′_{c} that it receives).

### ESX Construction Examples: Eviction

According to some embodiments, an eviction operation is called using a string y that specifies a path to leaf in T′, along with a target height h. It starts by emptying the path into a set S and calling ProcDels(S). After this call, all items in S appear exactly one or zero times. It then checks the target height h and compares to the length of Path(T′, h). If the path is too short, then it adds two leaves, and if it is too long, it deletes the final leaf. It then calls WrtPth, which calls WrtBkt on each node of the path (plus possibly the two new leaves), and WrtBkt packs every item from S into a bucket if the path determined by the PRF goes through that bucket.

### Example Security Considerations

Analyze the above constructions as an StE scheme: intuitively, updates leak only the number of additions and deletions in each epoch, as the size of the tree (and all of its slots and buckets) can be inferred from these values alone. Queries leakage an equality pattern because if x is queried multiple times, then the same leaf is requested multiple times.

To express this formally, for a tuple qrys of n sets and an element x, define the membership equality pattern meq(qrys, x) ∈{0, 1}ⁿ with i-th bit indicating if x is a member of the i-th set of grys.

### Example Proof

Let A be an efficient adversary. Give an efficient simulator S satisfying definition 4 with leakage profile L_{ESX} (FIG. 8B). The majority of this proof follows standard techniques and provides a sketch of them, with the focus on the novel portion dealing with the overflow probability.

Via easy reductions, assume that all evaluations of the hash function Π emit unique outputs, and replace all evaluations of F with random k-bit strings. In this version of the game, a simulator can use the leakage profile to simulate the server's view during Qry protocol executions, which consists of τ. It receives as input a multiset λ indicating how elements intersected with past queries, and from this infers the size of X_{qry}. It simulates T by selecting |X_{qry}| random strings, reusing past strings as indicated.

For updates, the server's view is the first message n (e.g., which is easy to simulate) and T′_{c}. It is easy to simulate n from the leakage k in the case of updates. For T′_{c} observe that it consists of a tree data structure filled with freshly-encrypted ciphertexts, each computed on a k-bit plaintext. By the security of the encryption scheme, these can be encryptions of a fixed k-bit string instead.

To complete the proof, argue that the simulator can calculate the shape of T′_{c}, and then show that overflows happen with negligible probability. Start with the former. Given the update leakage |X₊|, |X₋|, the simulator can simulate the client logic the determines h in the update protocol: It starts with sLoad=h=0 and tracks curDels, Dels, tₑₚ mimicking the protocol, except that uses the size of X₊ and X₋ to determine how these variables change rather than the actual sets.

Then using sLoad and h, the simulator can determine the shape of T′_{c}.
For the overflow analysis, adapt the proof of Gentry et al. and show that for any efficient adversary A, and at any time during the execution of the protocol, any particular bucket overflows with negligible probability. A union bound over the polynomial number of time steps and buckets gives the asymptotic bound.

Start by proving three invariants about our construction that control the “load” of the tree, meaning the number of real items in the tree, relative to its height.

Lemma 1. The following invariants hold for our construction:
1. At every step, the load on the tree is at most sLoad.
2. At every step, the load on the tree is at most 2^{min{h}^{₀}^{,h}^{₁}^{}}, where h₀ and h₁ are the heights of the tree at the beginning and end of the epoch.
3. At the end of every epoch, the load on the tree is at most 2^{h-1}, where h is the height of the tree at that time.

### Proof (of Lemma)

For the first invariant, observe that during an epoch, each operation adds one item to the tree, and possibly deletes some previous ones. While the system cannot control the exact time at which the previous items are deleted, the system knows that all deletes from the previous epoch will be deleted by the end of the epoch, and each such delete will remove two items from the tree. Thus, each epoch, in the worst case, increases the number of elements by the length of the current epoch divided by 8 and decreases by double the number of deletes in the previous epoch. The claim then follows.

Prove the second variant and third invariant together by induction. They both clearly hold at the start, when the first epoch has h₀=h₁=0 and there are no items stored in the tree. Now suppose the invariants hold at the end of some epoch with a tree of height h. During the next epoch, there are three possibilities: h is either increased, decreased, or unchanged. Consider these separately:
1. If h is decreased, then h₀=h, h₁=h−1 during this epoch. Since this epoch will decrease h, the number of items in the tree is at most 2h/8 at the start of the epoch. The next epoch will have length 2^{h-1}/8=2^{h}/16, and hence add that many items to the tree.
   To establish the second invariant, show that the load never exceeds 2^{min{h}^{₀}^{,h}^{ᵢ}^{}}=2^{h}/2 and that the load is at most 2^{h1 -1} 2^{h}/4 at the end of the epoch. But the load on the tree never exceeds

$${2}^{h} / 8 + {2}^{h} / 16 < {2}^{h} / 4 ,$$

which shows that both invariants hold for the case of a decreasing epoch.
2. If h stays the same, then h₀=h₁=h, and the tree holds fewer than 2^{h}/4 items. The next epoch will, in the worst case, add 2^{h}/8 items. Show that the load never exceeds 2^{min{h}^{₀}^{,h}^{₁}^{}}=2^{h} and that at the end of the epoch the load is no greater than 2^{h}/2. Since the epoch is not increasing the height of the tree, the system knows that the load is less than 2^{h}/8, and during the epoch the which establishes both invariants.

$${2}^{h} / 4 + {2}^{h} / 8 < {2}^{h} / 4 ,$$

3. If h increases, then h₀=h, h₁=h+1. To establish the invariants, show that during this epoch the load does not exceed 2^{min{h}^{₀}^{,h}^{₁}^{}}=2^{h} and that at the end of the epoch the load is less than 2^{h1}/2=2^{h} i.e. prove the same bound.
By the third invariant for the previous epoch, the system knows that the load on this tree is at most 2^{h1}/2. The next epoch will add 2^{h}/8 items to the tree, in the worst case. Thus, the load never exceeds as desired.

$${2}^{h} / 2 + {2}^{h} / 8 < {2}^{h} ,$$

Now return to the overflow analysis, fix an adversary that requests a total t update operations, and fix any bucket B of the final tree after the adversary halts. It is sufficient to prove that B overflows with negligible probability, as a union bound over all times and buckets shows that any overflow happens with negligible probability.

Let X be a random variable representing the number of items stored in B at the end. Then write

$$X = {\sum }_{i = 1}^{t} {X}_{i} ,$$

where Xᵢ is an indicator for the event that the item written at time i is in B at the end of the execution. Due to our lazy deletes, the Xᵢ are not the sum of i.i.d. 0/1 random variables (because a delete operation will inject an item with the same leaf as a previous operation). However, this dependence only helps our analysis since the same item cannot exist twice in any bucket. This is because the system immediately “cleans up” paths to remove duplicates in ProcDels, and in particular the same item will never be placed in the same bucket twice. In terms of our Xᵢ, this means that they are dependent, but only in the sense that for some i, j, Xᵢ=1 implies Xⱼ=0 (and similar relationships when one item is added and deleted several times).

Thus, write X=X′, where

$${X}^{′} = {\sum }_{i = 1}^{{t}^{′}} {X}_{i}^{′}$$

is a sum of t′≤t independent random variables indicating if the i-th unique item appears in B. Calculate the expectation of X then apply a relative-error Chernoff bound, which does not require knowing t′, and obtain a concentration bound for the number of items in B.
Proceed with the Expectation Calculation

Consider an epoch with starting and ending heights h0, h1, and let d be the depth of bucket B (here and below, length of paths refers to number of edges). Let c be the length of the shortest path from B to one of its leaf ancestors (so d+c ∈{h₀, h₁}, and d or c may be zero).

Now analyze the claim that: Lemma 2. E[X]≤2.

### Proof (of Lemma)

Analyze the cases c<2 and c≥2 separately. In the first case, observe that an item can be in B only if that item's leaf passes through B. By the second invariant, there are at most 2^{min{h}^{₀}^{, h}^{₁}^{}} items in total, and each of these has a path through B with probability 2^{-d}. Therefore, the expectation is at most

$${2}^{min \{ {h}_{0} , {h}_{1} \}} \cdot {2}^{- 2} \leq {2}^{c + d} \cdot {2}^{- d} \leq 2 ,$$

where the final step uses that c<2. Now assume instead that c≥2. Since there is a path of this length at least 2 below B, this is not the first visit to the node. The previous visit occurred 2^{d} steps ago, and after that visit there was at least one node below B, since the length of paths changes by at most one on each visit. The visits pass through two the distinct children below B, say u (on the last visit) and v (on the current visit). Any item assigned to B before the previous visit would have been flushed to either u or v or deeper. Any item assigned to B and through v will be flushed on the final visit. Therefore, the only items in B after the final visit must be items assigned through u in the last 2d operations. Since each of these has a leaf passing through u with probability 2−(d+1), the expectation is at most

$${2}^{d} \cdot {2}^{- ( d + 1 )} = 1 / 2 ,$$

which completes the proof of the lemma.

To complete the overflow analysis, use the observation above that X=X′, where X′ is a sum of independent random variables. By a Chernoff bound and the lemma showing E [X]≤4, for every δ>0 that

$$Pr [ {X}^{′} \geq 4 ( 1 + δ ) ] \leq {e}^{- 4 {δ}^{2} / ( 2 + δ )} .$$

$$For any Z \geq 8 , setting δ = ( Z - 4 ) / 4 gives$$

$$Pr [ {X}^{′} \geq Z ] \leq {e}^{{( Z - 4 )}^{2} / ( Z + 4 )} \leq {e}^{- Z / δ} .$$

Thus, the overflow probability is negligible when pad sets the bucket size to be ω(k) (which will be negligible in k for one bucket and also large enough to absorb the polynomial factors from the union bound).

### Example Server-Side Querying Version

The discussion now describes how to convert ESX which has query equality leakage into a server-side querying StE with minimal leakage. The update protocol remains the same, and the embodiment modifies the query the protocol. At a high level, replace the client's evaluation of the PRF F with an oblivious PRF, and then replace the client's computation in the latter part of Qry with a two-party protocol for determining which x appears an odd number of times in the appropriate paths. In various embodiments, the server can learn the intermediate PRF outputs and select the path from the tree it holds for the second part; this means that the second protocol uses an input that scales with log|X| rather than the entire set.

### Example SQry Sub-Protocols

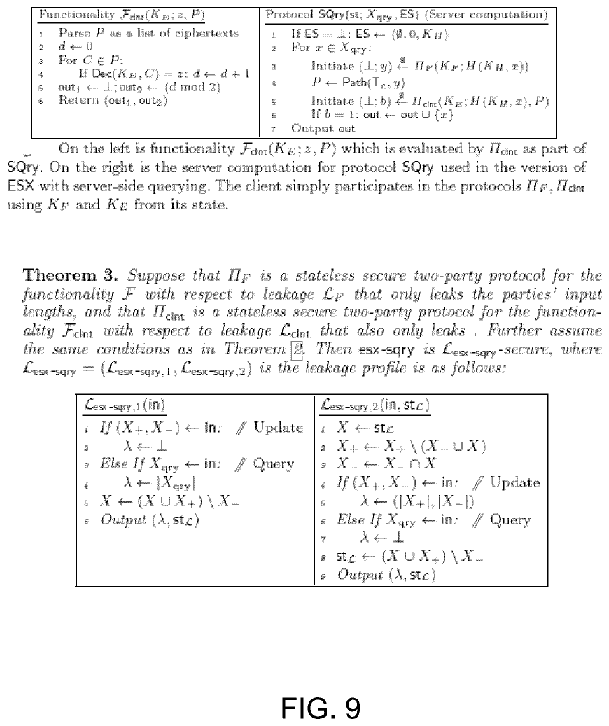

Assume two protocols Π_{F}, Π_{clnt} have been constructed. The first protocol evaluates the functionality F(K_{F}; z) that outputs (⊥; F (K_{F}, z)), i.e. provides the right party with the PRF output and the left party with no output. The second performs the client computation from Qry where it determines if a given value appears in an even or odd number of ciphertexts. Formalize this functionality as F_{clnt} on the top left side of FIG. 9. To further understanding, this protocol operates on a single path P instead of a subtree (as was the case in Qry). It is possible to consider a batched version that works on the subtree, but the added complexity did not seem to bring any advantages to the explanation of the operations/functionality.

### Example SQry Construction

FIG. 9 describes the protocol on the top right side. The code in that figure gives the server computation; the client only needs to participate in the sub-protocols Π_{F} and Π_{clnt}. The protocol works by iterating over the inputs in X_{qry}, evaluating the PRF on each and then feeding the resulting path into Π_{clnt}. The server can then compute its results (and the client has no output).

### Example SQry Security

The client view can be simulated given the size of X_{qry}— which matches exactly the leakage due to L_{clnt}. The server view for each update invocation can be simulated given just the sizes of sets X₊, X₋ which is the leakage for the client-query variant. For each query invocation this protocol has no leakage. That's because the server view containing correlated tree paths can be simulated given just the server input set Xqry—as the corresponding ES_{X} protocol's server view can be simulated given just the query equality leakage. Theorem 3, FIG. 9, encapsulates this leakage profile more formally in the following theorem.

As described, the leakage to client is stateless and only leaks the size of X_{qry}, while the leakage to the server consists of the number of valid additions and deletions. Recall that in the case of updates for the client, the leakage consists of extra information beyond its input X₊, X₋, and similarly for queries for the server with X_{qry}.

### Example Instantiation

One efficient way to construct Π_{F} and Π_{clnt} is to use an Oblivious PRF protocol and generic 2PC based on garbled circuits respectively.

The OPRF protocol by Jarecki and Liu based on the Decisional-Composite Residuosity (DCR) assumption also directly implements the functionality H_{F} in constant rounds, where the computation cost of both parties is O(1) DCR group exponentiations and the communication cost is O(1) DCR group elements.

In some examples, garbled circuits can be used to implement a non-reactive functionality where both parties input (C, x) and (C′, y) respectively. Further the functionality parses the two inputs C, C′ as circuit in some canonical representation, and the first party outputs C(x, y) if C=C′ and otherwise it outputs ⊥. The output of the second party is ⊥. Hence, note that the Π_{clnt} functionality can be implemented by garbled circuits functionality, where the code of Π_{clnt} can be translated into a circuit implementing decryptions and counting modulo 2.

Here, the computation complexity of SQry of both parties is dominated by O(|X_{qry}|) DCR-group exponentiations and ω(|X_{qry}|k² log|X|) CCR hashes and the communication cost is dominated by the size of the garbled circuit: ω(|X_{qry}|k³ log|X|).

### Updatable PSI Protocol Embodiments

Now described are embodiments of the new ES_{X} construction (above) with server side querying and an example PSU protocol into the updatable PSI framework from above to get an updatable PSI protocol. Using ES_{X} with server side querying has minimum leakage. The system ensures that in each epoch, the PSU invocations only leak |X₊|, |X₋|, |Y₊|, |Y₋| by padding the input sets S₁, S₂, (X−∩I₁), (Y−∩I₂) in stage 3 of the protocol with dummy elements, so each of these input sets |X₊|, |X₋|, |Y₊|, |Y₋| elements respectively. Hence, our updatable PSI protocol also has minimal leakage in each epoch—leaking nothing more than the size of the insert and delete sets.

### Example Complexity Considerations

Let η+|X₊|+|Y₊| and η−=X₋|+|Y₋|. Then asymptotic communication complexity in any epoch of our updatable PSI is ω(k log(|X∥Y|)(k²η+η₋)). The computation complexity of the first party is dominated by O(η₁) exponentiations and O(k(log(|X∥Y|)(kη₁+η₂)) hashes. The computation cost of party P_{Y} can be similarly obtained (by just reversing the sets X and Y in the complexity of P_{X}). A more fine grained breakdown of the complexity per stage of the protocol is listed next:
Stage 1: The communication cost of Upd invocation is ω(log|X|k(|X₊|+|X₋|)) and SQry invocation is ω(log|Y|k³|Y₊|). The computation cost of P_{X} is dominated by O(|Y₊|) DCR group exponentiations and O(log|Y|k²|Y₊|) hashes.
Stage 2: The communication cost of Upd^{r} invocation is ω(log|Y|k(|Y₊|+|Y₋|)) and Sqry^{r} invocation is ω(log|X|k³|X₊|). The computation cost of P_{X} is dominated by O(|X₊|) DCR group exponentiations and O(log|X|k²|X₊|) hashes.
Stage 3: The communication cost of the first and the second PSU invocation are O(kη₊) and O(kη₋) respectively. The computation cost of both parties is dominated by the O(η₊+η₋) hashes.

Various embodiments of the updatable PSI framework are limited to semi-honest security it is noted that examples of the ES_{X} construction are insecure if the adversary is allowed to adaptively pick elements to insert and delete—since this could cause overflow in the ES_{X} tree with non-negligible probability.

Updatable private set operations beyond PSI. For most PSI related privacy-preserving applications, the parties are interested in learning some function of the intersection (like cardinality and weighted sum) instead of the explicit intersection.

Example Dynamic StE Scheme—with Server Side Querying

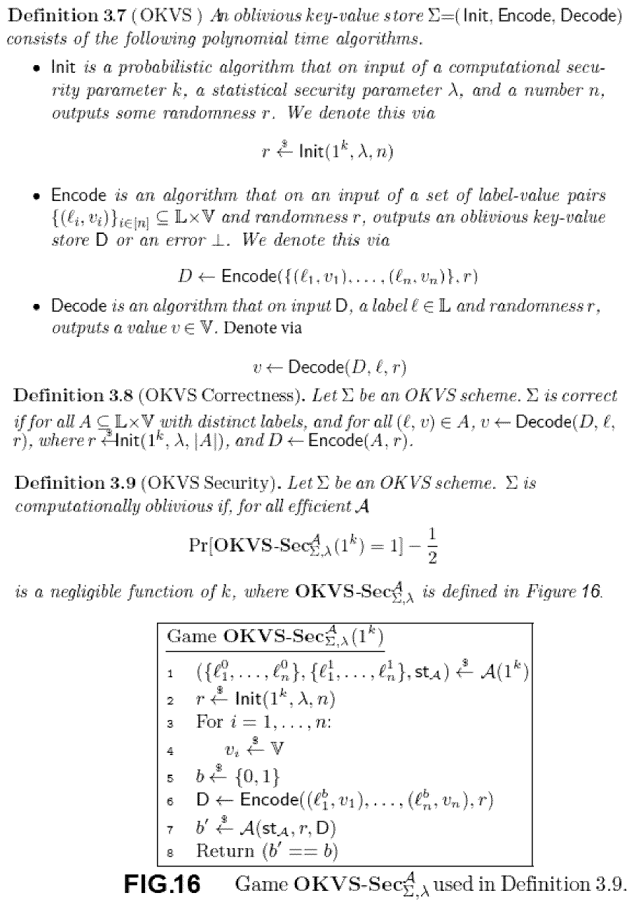

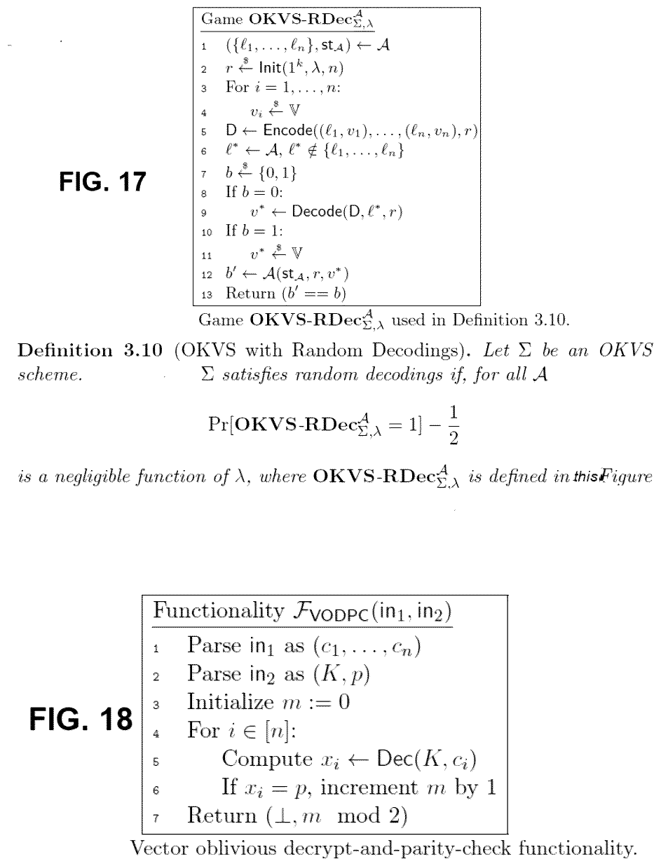

Various embodiments provide a new dynamic StE scheme with server side querying, OSX which can be based on oblivious key-value stores. OSX is implemented in conjunction with a PSU protocol in the general framework to instantiate a new UPSI protocol. An oblivious key-value store (OKVS) is a dictionary data structure that maps keys to values in a way that hides the set of keys encoded within the structure. To avoid any confusion between keys stored within an OKVS and cryptographic keys, the description refers to the keys used within the OKVS as labels. Assume that labels belong to a label space L and values belong to a value space V. Formally, an example OKVS is defined in FIG. 16.

In this example, the definition differs slightly from the other implementations, it includes an Init algorithm in order to make the randomness r an explicit output/input of both Encode and Decode. Refer to the set of labels encoded in D using the Encode algorithm as being “in” the OKVS, and the remaining labels as being not in the OKVS. Next, define the correctness of an OKVS. An OKVS is considered correct if Decode returns the correct value for all the labels in the OKVS. define security for OKVS, which requires it to hide the labels in the OKVS. Intuitively, an OKVS is oblivious if an efficient adversary cannot distinguish between the encodings of two sets of labels when the values are chosen uniformly at random from V. Stating the random decoding property of an OKVS, various embodiments of a set encryption scheme OSX utilize this property to satisfy correctness. Various example solutions have been developed based on polynomials, random band matrices, and cuckoo tables.

### Example Implementation: Vector Oblivious Decrypt and Parity Check

Various embodiments, develop an encrypted set construction using new non-interactive functionality known as the Vector Oblivious Decrypt-and-Parity-Check (VODPC) functionality, depicted in FIG. 18. This functionality accepts as input from the first party a vector \vec{c}=(c₁, . . . , cₙ) of ciphertexts, and from the second party a key K and a plaintext p.

Subsequently, the functionality decrypts the ciphertexts using key K and counts the number of plaintexts that match the input plaintext p. If the count is even, it outputs a 0 to the second party, and otherwise, it outputs a 1. VODPC is similar to the VODM functionality introduced by Zhang et al. described in “Linear private set union from {Multi-Query}reverse private membership test.” However current implementation alters that approach and instead of counting the number of plaintexts matching p, generates a boolean vector. In this vector, the i-th entry is 1 if cᵢ decrypts to p, and 0 otherwise.

### Example Implementation: (OSX) A Set Encryption Scheme with Server-side Querying

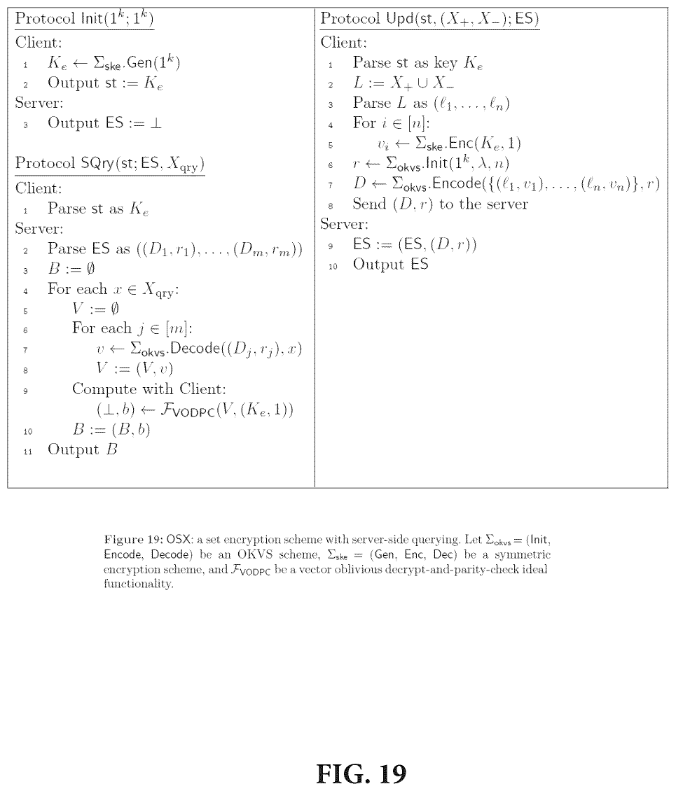

Various embodiments utilize OSX, an encrypted set scheme with server-side querying. Various embodiments use OSX with the described general UPSI framework to describe a practically efficient updatable PSI protocol. The pseudocode for OSX is given in FIG. 19. At a high-level, OSX uses multiple OKVS structures to represent an encrypted set. One OKVS is created for each (batch) update to the set structure, where the labels in the OKVS are the elements that are being updated, and the value for every label is a ciphertext that encodes a constant. In FIG. 19, 1 is used as the constant to denote that an update operation was performed on the corresponding label. Note that both additions and deletions are represented by the special ciphertext for 1.

Intuitively, to query x, the system can query every OKVS for the label x and count the number of ciphertexts that decrypt to 1. If the number is even, x is not currently in the set, and if the number is odd, x is in the set. However, further embodiments recognize that the client holds the key to decrypt the ciphertexts, and support for server-side querying with low leakage can be implemented.

According to some embodiments, for each element of X_{qry}, the server queries all the existing OKVSs to retrieve some ciphertexts. The client and the server then invoke F_{VODPC}, which decrypts the ciphertexts, counts the number of ciphertexts that decrypt to 1, and outputs the parity of the final count. The resulting query leakage to the client is the number of queries the server made, and there is no query leakage to the server by the security of the encryption scheme, the obliviousness of the OKVS, and the invocation of F_{VODPC}. Proof of the security and correctness of OSX follows.

### Example Correctness Proof

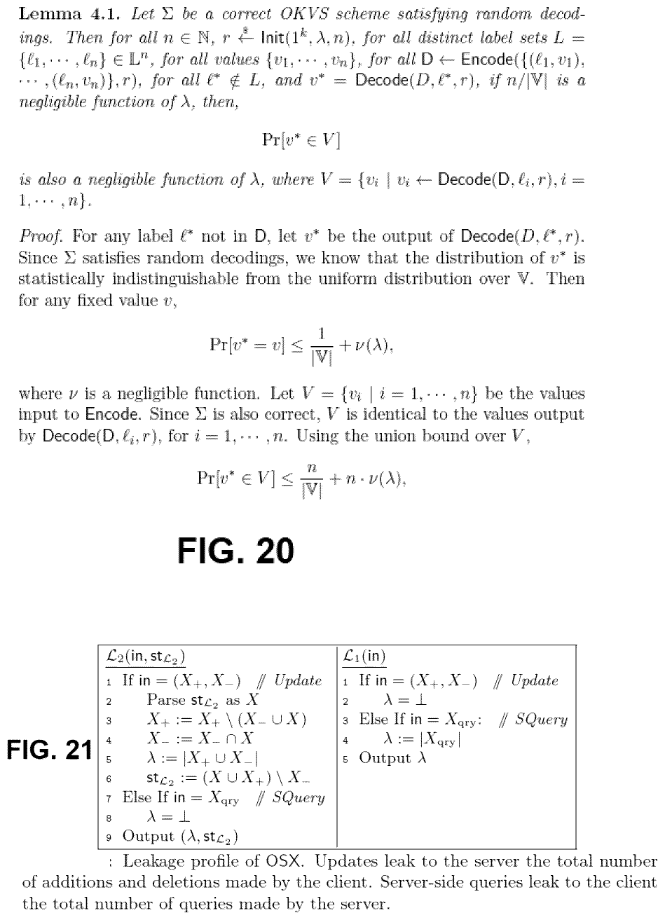

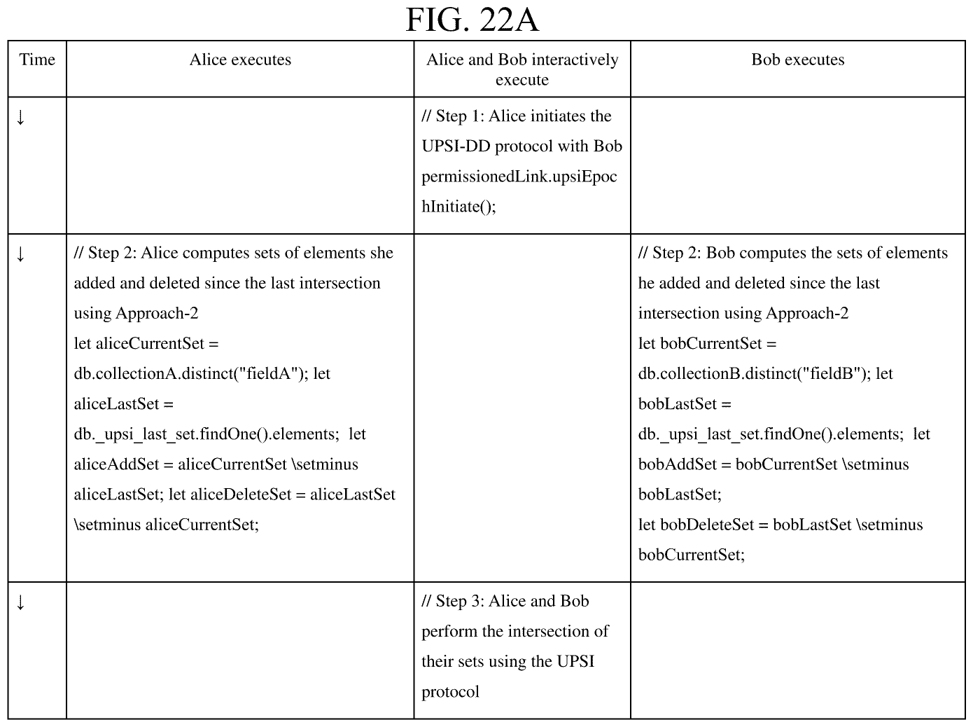

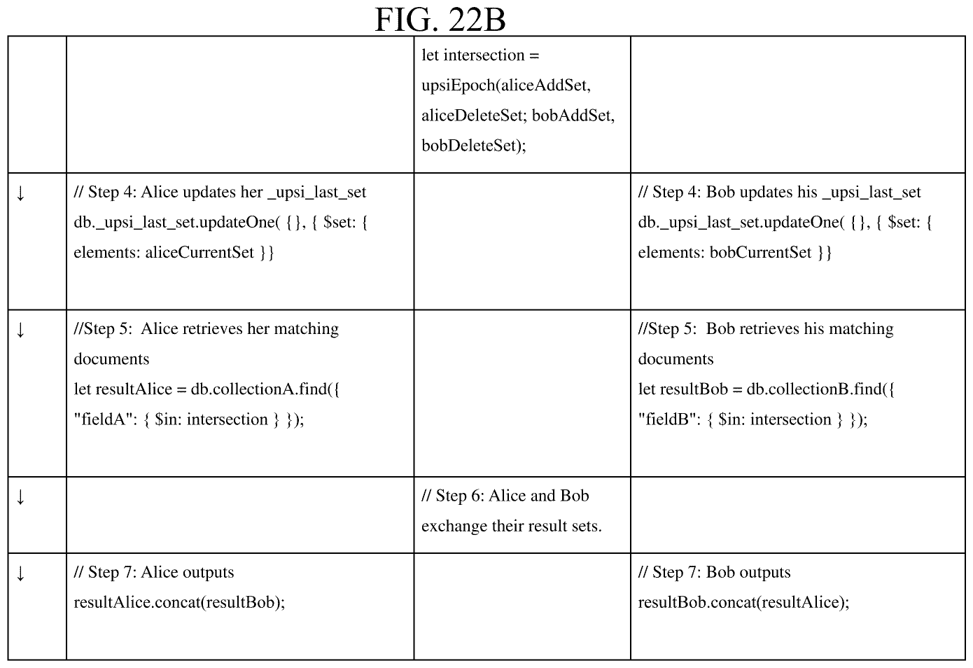

The correctness of OSX with server-side querying in the FVODPC-hybrid model can be established as described in FIG. 20. First prove a property of an OKVS scheme Σ, given that Σ satisfies random decodings, and that the value space for E is large enough in the statistical security parameter. Given that n is polynomially bounded in a, and n/IVI is a negligible function of a, we have the proof of the lemma.

Given an authenticated encryption game requires the adversary to produce a valid ciphertext that it did not query its encryption oracle for. Assume a B that wins

$${Cor}_{OSX}^{B}$$

with non-negligible probability. Use B to build an efficient adversary A for the authenticated encryption scheme Σₛₖₑ as follows: A simulates B, and performs all operations according to the OSX protocol, except that whenever it has to encrypt a 1, A makes a call to the AE encryption oracle. Finally, when B wins the game, A looks at the query set Xqry and identifies one element x such that, x ∈Xout and x/∈X, (or) x/∈Xout and x ∈X. For this element, A collects all the outputs of the m OKVSs (assuming some m=poly(k) update operations), and removes the outputs that were generated by the AE oracle. Then there must be at least one valid AE ciphertext in the remaining outputs. If A guesses one uniformly at random, it then has at least 1/m probability of winning the AE game, completing the reduction (assuming that OKVS correctness and B winning probability are 1 for simplicity).

### Example Security Considerations OSX

According to one embodiment, analysis the security of OSX with server-side querying in F_{VODPC}-hybrid model follows. Leakage is formally described in FIG. 21. The leakage to the client is denoted as L₁ and is stateless. The client leakage is the number of queries the server makes. This leakage occurs because the client needs to input its encryption key |X_{qry}| times in the FVODPC functionality which reveals the size of the query set. The server leakage, denoted as L₂, is stateful and leaks the total number of valid additions and deletions made by the client. Intuitively, the server can infer |X₊∪X₋ | from the size of the OKVS the client sends to it.

Now prove security against a corrupted client. Simulate the client's view from its leakage L₁ and its inputs. More precisely, for all efficient adversaries A we must give an efficient simulator Sim_{C} satisfying definition 5, (e.g., FIG. 5) with leakage profile L₁. The simulator Sim_{C} works as follows.
1. Starts by simulating the real client C.
2. Update operation, receives inputs X₊, X₋, and leakage k=L. Forwards the inputs X₊, X₋ to C. It then appends the messages/outputs of C to its view V.
3. On a server-side query, receives only the leakage λ=|Xqry|. For |Xqry| times, initiates FVODPC with C. It then appends the messages/outputs of C to its view V.
4. Finally, it outputs the view V.
   The view output by SimC is indistinguishable from the view of the corrupted client in the real world. When an update occurs, C receives the same input X₊ and X₋ as it would in the real world. Henceforth, it does not receive any messages from the server in the real world, and so the simulator does not need to simulate anything else for C during an update protocol. Consequently, the views are indistinguishable for the update protocol. During server-side queries, the only action the client takes in the real world is to input its key to F_{VODPC} functionality |X_{qry}| times. Given the leakage |X_{qry}|, the simulator performs the correct number of invocations of the F_{VODPC} functionality with C. Hence, the views of C are indistinguishable for the server-side queries as well.

Now prove security against a corrupted server: simulate the server's view from its leakage L₂ and its inputs and outputs. The simulator Sim_{S} works as follows:
1. It starts by simulating the real server S. It then samples a key Kₑ←Σₛₖₑ(1^{k}).
2. On updates, it receives leakage λ=|X₊∪X₋|. It lets n:=|X₊∪X₋| For i ϵ[n], it samples:

$${x}_{i} \text{?} 𝕃 and {v}_{i} \text{?} 𝕍 .$$

$$\text{?} \text{indicates text missing or illegible when filed}$$

It then (initializes an OKVS as r←Σₒₖᵥₛ.Init(1^{k}, n), and computes D←Σₒₖᵥₛ. Encode({(x₁, u₁), . . . , (xₙ, vₙ)}, r) It then sends (D, r) to the simulated server. Finally, it appends the outputs/messages of S to its view V.
3. On server-side queries, it receives the server's input X_{qry} and output B, and leakage λ=⊥. It then forwards the input X_{qry} to the simulated server S. When S invokes the [symbol] _{VOPC} functionality the i-th time, it outputs the i-th bit in vector B. Finally, it appends the outputs/messages of S to its view V.
   The view output by Sim₅ is indistinguishable from the view of the corrupted server in the real world. Proof uses the standard hybrid argument, in particular, defining four hybrids Hybrid0, Hybrid1, Hybrid2, it is shown that Hybrid0 is same as the real world, Hybrid3 is same as the ideal world, and each consecutive hybrid is indistinguishable from each other to the corrupted server.
Hybrid0 is the real interaction as described in FIG. 19. Here, the corrupted server S interacts with an honest client C.
Hybrid1 is identical to Hybrid0 except for the way in which the server receives outputs during server-side queries. In Hybrid1, for an element x ϵX_{qry}, it receives a bit b, where b=1 if x is currently in the set X and 0 otherwise. In contrast, in Hybrid0, it receives outputs from F_{VODPC} instead. We show that the outputs of FVODPC in Hybrid0 and Hybrid1 are essentially the same, except for a negligible probability in the statistical security parameter λ. This is because the correctness and the random decodings of Σₒₖᵥₛ ensure that in Hybrid0, for an x∈X_{qry}, the F_{VODPC} outputs a 1 iff x is currently in the set X. Therefore, the games are indistinguishable, except with a negligible probability of λ. Let (D, r) be an OKVS, and let L=(x₁, . . . , xₙ) denote the set of elements in D. If an element xi ∈L, then Decode(Encode({(x₁, c₁), . . . , (xₙ, cₙ)}, ᵣ), xᵢ)=cᵢ. In our case, since vᵢ=Enc(Kₑ, 1), this means that if xi ∈L, then Σₒₖᵥₛ decodes it to an encryption of 1. Also show that if xᵢ ∉L, then Σₒₖᵥₛ does not decode xi to an encryption of 1. If it does, F_{VODPC} may compute the parity incorrectly and return a wrong result for whether xi is in X. Σₒₖᵥₛ has random decodings, which implies that for an xᵢ/∈L, cᵢ=Decode((D, r), xᵢ) is a random ciphertext. Therefore, it is not an encryption of 1 with overwhelming probability. The union bound guarantees that for all xᵢ ∉, the probability of this occurring is negligible. Now in the SQry protocol, for each x ∈X_{qry}, the server queries all m OKVSs. For reasons given above, if x is in the set, an odd number of m ciphertexts will decrypt to 1 and the remaining will not decrypt to 1. The F_{VODPC} thus computes an odd parity and thus returns b=1. Similarly, if x is not in the set, none of the ciphertexts will decrypt to 1, and thus the parity is even. Therefore, F_{VODPC} outputs b=1.
Hybrid2 is same as Hybrid1 except that the corrupted server now receives an oblivious key-value store D that encodes random values instead of encryptions of 1, i.e., D←Σₒₖᵥₛ. Encode({(x₁, v₁), . . . , (xₙ, vₙ)}, r), where

$${v}_{i} \text{?} V$$

$$\text{?} \text{indicates text missing or illegible when filed}$$

for all i ∈[n]. Hybrid2 is indistinguishable to Hybrid1 because Σₛₖₑ is RCPA secure and hence all Enc(Kₑ, 1) are indistinguishable from random ciphertexts.
Hybrid3 is same as Hybrid2 except that the corrupted server now receives an oblivious key-value store D that encodes random labels, i.e., D←Σₒₖᵥₛ. Encode({(x₁, v₁), . . . , (xₙ, vₙ)}, r), where xᵢ

$$\text{?} L$$

$$\text{?} \text{indicates text missing or illegible when filed}$$

for all i∈[n]. We note that Hybrid3 is indistinguishable from Hybrid2 to the server due to the oblivious property of OKVSs. The proof is concluded by noting that Hybrid3 is the same as the experiment in the ideal world.
According to various embodiments, OSX is integrated with the frameworks described above (e.g., Framework for Updatable PSI, including from StE for Sets, etc.) to implement various embodiments of an updatable private set intersection protocol from a structured encryption scheme for encrypted sets with server-side querying.

Additional embodiments provide for private set intersection in the context of known database system, including, for example, MongoDB. For document based database systems, UPSI protocols are translated where the parties are not holding sets of elements but instead a database of documents—providing novel solutions in the case of document databases (referred to as PSI-DD). Each document in the database is a set of field/value pairs. In this context, the problem is translated as follows:
Both Alice and Bob agree on a field f.
The output of the PSI protocol returns all documents in Alice's and Bob's databases that have the same values for field f.
However, Alice should not learn any information about any other documents in Bob's database, and Bob should not learn any information about any other documents in Alice's database.
   Example: As an example, consider the following databases for Alice and Bob. If they decide to compute an intersection over the age field, the documents D11, D13, and D14 from Alice's database and D21 and D22 from Bob's database are returned. This is because both databases contain at least one document with ages 18 and 27. If instead, they decide to compute an intersection over the insurance field, the documents D11, D12, and D22 are returned.

### Alice's Database:

Document D11: {age: 18, insurance: “cigna” }
Document D12: {age: 20, insurance: “cigna” }
Document D13: {age: 18, insurance: “aetna” }
Document D14: {age: 27, insurance: “aetna” }

### Bob's Database:

Document D21: {age: 18, insurance: N/A}
Document D22: {age: 27, insurance: “cigna” }
Document D23: {age: 46, insurance: “guardian” }
   Equivalence between the standard PSI and PSI for document databases (PSI-DD). A PSI-DD problem instance can be converted into a standard PSI instance by treating the values associated with the chosen field in PSI-DD as sets in PSI. The process involves:
1. First, extracting the values associated with the chosen field from both databases as sets.
2. Performing the intersection of these sets using a standard PSI protocol.
3. Returning all documents from either database where the chosen field has a value present in the intersection.
   For instance, in the example above, take the following steps to compute the intersection for the age field:
1. Extract the sets of ages:
   Alice's set of ages: {18, 20, 27}
   Bob's set of ages: {18, 27, 46}
2. Compute the intersection:
   Intersection: {18, 27}
3. Return all documents where the age field has a value in the intersection:
   Documents returned from Alice's set: D11, D13, and D14
   Documents returned from Bob's set: D21 and D22
      In MongoDB, step 3 can be executed by both drivers making a find query to retrieve the documents that match the intersection values. This equivalence allows a study of the standard PSI problem independently, develop efficient solutions, and then apply these solutions to the PSI-DD problem. Similar approaches have been implemented in the context of other dynamic schema and/or document based database systems.
      Example Variants of PSI-DD. In the PSI-DD variant discussed above, Alice receives both her documents and Bob's documents, which contain values from the intersection. Alternatively, depending on the use case, the system can implement another variant of PSI-DD where Alice receives only her documents that contain a value in the intersection. In contrast, Bob receives only his corresponding documents. For example, in the scenario described, Alice would receive documents D11, D13, and D14, while Bob would receive only D21 and D22. These two variants offer slightly different functionalities, and the choice between them depends on the specific requirements of the use case. The following description starts with the first variant

### Example PSI-DD in MongoDB

To enable MongoDB customers to perform PSI-DD, three steps can be involved:
1. Linking the parties to enable communication between them
2. Granting permissions to each other
3. Performing the PSI-DD computation
   Example Outline of steps: agnostic of the specific intra-party communication architecture chosen. The description provides a high-level overview of the steps for each party. Once the intra-party communication architecture is chosen, the description elaborates on the components of each party that are responsible for executing these steps.

### Linking the Two Parties

According to one embodiment, the first step involves establishing a secure connection between the two parties who wish to perform PSI-DD or any other form of 2PC or MPC. This process, known as linking, involves creating a secure communication channel between the parties. For instance, if Alice and Bob, two MongoDB users, want to perform PSI-DD on their databases, they must first create a link using urlStringA and urlStringB as their respective identifiers: link=network.link(urlStringA, urlStringB); Once Alice and Bob agree and the linking process is successful, both parties receive a link that allows them to securely send messages to each other.

### Granting Permissions

For example, the link created in Step 1 allows the parties to communicate. Next step: grant each other permissions to perform computations on specific collections and fields. This is done by creating permissioned links that define the collections, fields, and types of operations that can be performed. For example, if Alice and Bob wish to perform PSI-DD on their respective collections, collectionA and collectionB, and fields fieldA and fieldB, they would grant each other permissions as follows: permissionedLink=link.grantPermissions(collectionA, collectionB, fieldA, fieldB, “psi”).

In some examples, the system can be configured for creating permissioned links for specific collections and fields enhances security by ensuring that a party granted access to one field cannot inadvertently or maliciously access or compute PSI-DD with fields that the other party did not authorize. This granular control over field-specific access helps maintain data privacy, preventing unauthorized intersections and limiting potential exposure of sensitive information.

For example, if Alice grants Bob access to perform PSI-DD on the age field in collectionA, but not on the insurance field, Bob cannot exploit the link to gain access to the insurance field of Alice. This isolation ensures that each field's data is protected and only shared as explicitly agreed upon, reinforcing security in collaborative data operations.

### The PSI-DD MQL Operator

According to one embodiment, once the parties establish a permissioned link, they can use MongoDB's query language (MQL) to perform secure computations. For PSI-DD, a new operator called privateMatch can be introduced in MQL (or other query language native to a respective database implementation). For example, when Alice wants to securely compute the intersection of collectionA.fieldA with Bob's collectionB.fieldB, she executes the following command:

$$intersection = permissionLink \cdot privateMatch ( )$$

Behind the scenes, the privateMatch operator implements a PSI-DD protocol, which, in turn, relies on a PSI protocol. Specifically, the pseudocode for the privateMatch operation is as follows (assuming, without loss of generality, that Alice executes the operation):

```
function privateMatch(collectionA, fieldA, collectionB, fieldB) {
  // Step 1: Alice initiates the PSI-DD process by sending a request to Bob
  permissionedLink.psiInitiate( );
  // Step 2: Alice Bob independently extract values associated with the chosen fields as sets.
  let aliceSet = db.collectionA.distinct(“fieldA”); // Alice extracts her field values
  let bobSet = db.collectionB.distinct(“fieldB”); // Bob extracts his field values
  // Step 3: Alice Bob perform the intersection of their sets using a standard PSI protocol. The
  intersection is computed interactively through the PSI protocol.
  let intersection = psiProtocol(aliceSet, bobSet);
  // Step 4: Alice and Bob query their respective databases to retrieve documents containing
  the intersection values.
    let resultAlice = db.collectionA.find({ “fieldA”: { $in: intersection } }); // Alice retrieves
  her matching documents
    let resultBob = db.collectionB.find({ “fieldB”: { $in: intersection } }); // Bob retrieves his
  matching documents
  // Step 5: Alice and Bob exchange their result sets.
  // Step 6: Alice and Bob combine their results to obtain the final union of matching
  documents.
      Alice outputs resultAlice.concat(resultBob);
      Bob outputs resultBob.concat(resultAlice);
}
```

In some embodiments, the PSI protocols from Step 3 would typically involve multiple rounds of communication, making them interactive. Therefore, the protocol can be configured to manage both parties so that they remain online throughout the PSI-DD computation process, or to terminate and resume upon connection. In some examples, state information can be used to resume operations that require interaction.

### Updatable Private Set Intersection (UPSI)

For many PSI applications, including online advertising and password breach monitoring, set intersections are computed multiple times as the sets grow or shrink over time. This concept of updatable PSI (UPSI) is particularly useful in database settings where two parties, such as database users, wish to compute intersections multiple times as they add or remove data from their databases.

Using PSI protocols for UPSI. Given a PSI protocol, performing updatable PSI includes: run the PSI protocol whenever an intersection is needed. For instance, suppose Alice and Bob have initial sets A and B. They first run the PSI protocol to compute the intersection I. If Alice updates her set to A′ and Bob updates his to B′, they can simply run the PSI protocol again to compute the new intersection I′.

Example Advantages of designing UPSI protocols. Instead of repeatedly using a PSI protocol, embodiments use a UPSI protocol specifically designed for efficiently computing multiple intersections. Here, “efficient” covers having communication and computation complexities that are sublinear relative to the size of the current sets (instead of linear). By leveraging UPSI protocols, updates to the intersection results are processed more efficiently, saving on both computational and communication overheads. UPSI protocols thus provide a more efficient solution for scenarios where set intersections need to be computed multiple times, making them highly suitable for dynamic database environments.

A Framework for Updatable PSI from StE for Sets

Embodiments use the UPSI framework discussed herein to construct an updatable PSI (UPSI) protocol. The framework uses a dynamic Structured Encryption (StE) scheme with server-side querying and any Private Set Union (PSU) protocol. Provided is an overview of the framework for clarity and completeness. The general UPSI framework is illustrated in the FIG. 6.

### Example Framework Overview

The framework uses a dynamic Structured Encryption (StE) scheme to create, update, and query the encrypted sets on the server side. Parties are P_{X} and P_{Y} with input sets X and Y. Let X₊ and X₋ be the elements that P_{X} wants to add and delete from set X, and similarly, Y₊ and Y₋ for P_{Y}. Given the existing intersection I=X∩Y, for one epoch of updates, notice that the updated intersection:

$$I ’ = ( I \backslash W ) ⋃ U ,$$

$$where ,$$

$$W = ( {X}_{-} ⋂ I ) ⋃ ( {Y}_{-} ⋂ I ) , and U = ( {Y}_{+} ⋂ X ’ ) ⋃ ( {X}_{+} ⋂ Y ’ ) ,$$

and X′ and Y′ are the updated sets X and Y. The framework allows the parties to compute the sets U and W, and given these sets, the parties can then compute the updated intersection locally. In the framework, each party holds an encrypted data structure that represents the other party's current set, and proceeds as follows:
Set U (elements to be added to the current intersection): P_{X} first updates the encrypted set X to X′ (held by P_{Y}). After the updates, P_{Y} runs the server-side membership query protocol on the encrypted set X′ to compute (Y₊∩X′). By the symmetric process, P_{X} computes (X₊0 Y′). The parties then use a PSU protocol to compute the set U.
Set W (elements to be removed from the current intersection): P_{X} computes (X₋ ∩I) locally, and similarly, P_{Y} computes (Y₋∩|). They then use a PSU protocol to compute the set W.

In more detail, the framework incorporates each party's additions X₊, and Y₊ and deletions X₋ and Y₋, and computes the updated intersection as follows, assuming that each party holds an encrypted set representing the other party's previous set and knows the intersection of these previous sets, denoted as I₁ and I₂, where I₁=12. In the first epoch of the protocol, these encrypted sets and the intersection can be considered empty.
1. Input Validation: Both parties ensure their updates, X₊, X₋, and Y₊, Y₋, are well-formed (e.g., only deleting elements that are present in their sets, and only adding elements that are not currently present in their sets).
2. First Interactive Stage:
   P_{X} acts as the client and runs the update protocol from the StE scheme to perform the updates X₊ and X₋ on its encrypted set ES_{X}, which is held by P_{Y}.
   P_{Y} then uses the server-side query of the StE to query the updated ES_{X} with its additions Y₊. The output to P_{Y} is the set S₂=(Y₊0 X′).
3. Second Interactive Stage: This stage is symmetric, with the roles of the parties reversed. At the end of this stage, party P_{X} gets the set S₁=(X₊0 Y′).
4. Union Computation:
   The parties run a PSU protocol on sets Si and S₂ to learn their union U=S₁ ∪S₂. In the figure, U is denoted as U=U₁=U₂. The parties must add U to the current intersection.
   The parties run a PSU protocol again with the inputs (X₋∩I₁) and (Y₋∩I₂) to compute the set W. In the figure, W is denoted as W=W₁=W₂. The parties must remove W from the current intersection
5. Intersection Update: Both parties locally update the previous intersection to compute the new intersection.
   OSX: A Set StE Scheme with Server-side Querying
   The UPSI framework herein uses a set encryption scheme with server-side querying as one of its key components. To instantiate this within the framework, embodiments use OSX, a set encryption scheme with server-side querying described herein.
   Example Structured Encryption (StE) schemes. StE schemes are encryption techniques that allow data structures to be encrypted in such a way that they can be privately queried. In a standard setting, StE schemes allow:
1. Setup: At setup time, the client, the owner of the data structure, encrypts the structure and uploads it to an untrusted server.
2. Updates and Queries: The client can later update (by adding or deleting elements) and query the encrypted data structure.
   In traditional StE schemes, the client issues both updates and queries. These schemes have been extensively studied since the early 2000s, focusing on ensuring that the server does not learn anything about the data or the queries (beyond minimal leakage).
   StE Schemes with Server-Side Querying. In contrast, StE schemes with server-side querying allow the untrusted server to issue queries on the client's encrypted data structure, rather than requiring the client to perform those queries. Shown herein is how to convert client-side query protocol of standard StE schemes into a server-side query protocol. This conversion effectively enables modification of standard StE scheme to support server-side querying, broadening its applicability to scenarios where the server must query on encrypted data (as required in the UPSI framework).
   StE Schemesfor Sets. A set encryption scheme is a StE scheme tailored for sets of elements. The scheme allows:
1. Set Encryption and Updates: The client can encrypt a set of elements and subsequently update it by adding or deleting elements.
2. Membership Queries: The scheme supports membership queries, allowing the client to check whether specific elements are present in the current set.
   In cases where the scheme supports server-side querying, these membership queries are issued by the server rather than the client.

### Overview of OSX

The UPSI framework describes use of a set encryption scheme with server-side querying as one of its components. To instantiate this within the framework, use OSX, a set encryption scheme with server-side querying discussed herein. OSX itself includes building blocks:
1. Oblivious Key-Value Store (OKVS)
2. F_{VODPC} Ideal Functionality
   Discussed is a brief overview of the OSX scheme and reference to detailed explanation above (e.g., FIG. 6).

Example Batch Update process. At a high level, OSX uses multiple OKVS structures to represent an encrypted set. Each update is represented by a new OKVS, where the labels correspond to the elements being added or deleted, and their values are ciphertexts representing the constant “1.” In particular, the batch update process works as follows. The client encodes the elements in X₊ and X₋ as labels in an OKVS, with the corresponding values being ciphertexts of the constant “1.” Once the OKVS is constructed with the updated elements, the client sends this new OKVS to the server. The server stores this new OKVS alongside all previous OKVS structures it has received from the client. The set of all the OKVSs together represents the encrypted set.

Example Server-side (batch) query process. To query an element x, the server queries every OKVS for the label x and counts the number of ciphertexts that decrypt to “1.” If the count is even, x is not currently in the set; if the count is odd, x is in the set. However, the client holds the key to decrypt the ciphertexts and we want to support server-side querying with minimal leakage.

Therefore, the server-side query protocol operates as follows:
1. For each element in the query set X_{qry}, the server queries all existing OKVSs to retrieve the corresponding ciphertexts.
2. The client and server then jointly invoke the F_{VODPC} protocol, which securely decrypts the ciphertexts, counts the number of “1” values and outputs the parity of the final count to the server.
   The query leakage to the client is limited to the number of queries the server made, while the server learns nothing about the client's set due to the encryption scheme's security, the obliviousness of the OKVS, and the privacy guarantees provided by F_{VODPC}.

### UPSI for Document Databases (UPSI-DD)

Below is described an example instantiation of the PSI-DD problem, for example, in MongoDB. A similar approach is used in other embodiments for other document based databases and/or other dynamic schema databases.

Updatable Private Set Intersection for Document Databases (UPSI-DD) extends the concept of PSI-DD to allow MongoDB customers to securely compute intersections over their databases multiple times, even as the databases are updated. This capability is useful for applications where the data is frequently changing, and the intersections need to be recalculated regularly. The workflow for UPSI-DD is similar to the one for PSI-DD, with the added flexibility of handling updates between intersections. The steps involved are:
1. Linking the Parties: The parties establish a secure link, allowing them to communicate with each other.
2. Granting Permissions for Computation: The parties grant each other permissions to perform computations on specific collections and fields
3. Making Updates to the Database: The parties can repeatedly update their databases as needed, with the updates being communicated to the other party to keep their encrypted sets synchronized.
4. Performing the UPSI-DD Computation: The parties can also repeatedly compute the intersection of the specified fields.

### Making Updates to a UPSI-enabled Database

In this section, detailed is how the existing database update operations are modified to seamlessly integrate with intersection operations on a UPSI-enabled database. Recall for a UPSI framework, when a party updates its database, these updates are also communicate to the other party. For instance, when using OSX to instantiate StE in the UPSI framework, the party would create an OKVS that encodes the elements being added or deleted and send this OKVS to the other party. As an example, consider Alice's database, which initially contains the following documents: Alice's Database:
Document D11: {age: 18, insurance: “cigna” }
Document D12: {age: 20, insurance: “cigna” }
Document D13: {age: 18, insurance: “aetna” }
Document D14: {age: 27, insurance: “aetna” }
   Suppose Alice decides to update the age field in Document D12 from 20 to 55. This change is equivalent to removing the value 20 and adding the value 55 to her set of ages, changing it from {18, 20, 27} to {18, 55, 27}. To maintain the correctness of the intersection protocol, Alice updates her encrypted set of ages that Bob holds. She does this by creating an OKVS that includes labels for both 20 (to be removed) and 55 (to be added), with their values being ciphertexts of “1.” This OKVS is then sent to Bob, who updates the encrypted set accordingly.

### Batching Updates

In the example, Alice can communicate with Bob every time she makes an update to her database. This approach would require Bob to be continuously online to receive Alice's updates, which is both inefficient and impractical in real-world settings. To address this issue, embodiments batch updates between intersections. Instead of sending updates immediately, parties accumulate their changes and send them in a single batch right before the next intersection computation. This approach eliminates the need for the other party to always be online to receive updates, enhancing efficiency and practicality. Additionally, since both parties are required to be online for the intersection computation anyway, the batching of updates aligns well with the existing workflow. Embodiments can implement a number of approaches for batching updates. Two example approaches are described for batching updates. Described are two methods for accumulating updates in a UPSI-DD system:
1. Incremental Metadata Tracking: In this approach, each party maintains metadata that is updated with every change made to their respective databases. This metadata essentially keeps a log of all updates performed. For instance, when Alice updates her database, the update operation simultaneously modifies her metadata to reflect these changes.
2. Intersection-Time Metadata Tracking: In the second approach, the parties maintain metadata that only tracks the elements in the set at the time of the intersection. This metadata is updated when the parties are preparing to perform an intersection, rather than with every database update.
   The second approach has several advantages over the first (while either/both can be used):
Reduced Overhead: The first approach imposes additional overhead on every database update operation, as each operation must also update the corresponding metadata. This continuous updating process can be resource-intensive and may slow down normal database operations.
Avoidance of Write Conflicts: In the first approach, since all update operations attempt to modify the same metadata, the metadata can become a bottleneck, leading to significant write conflicts and reduced throughput.
Simplicity: The second approach is inherently simpler. By deferring metadata updates until the intersection is needed, it avoids the complexities and potential performance issues associated with continuously tracking every change.

### Example Implementation: Incrementally Tracking Updates

### Metadata Collection and Document

For each UPSI-DD field, a special meta collection named_upsi_metadata is created in the user's database. This collection contains a single document that holds two array fields: current_set and updates_made.
current_set: This field stores the elements currently present in the user's set.
updates_made: This field tracks the elements that have been added or removed since the last intersection. After each intersection is computed, the updates_made field is cleared out and reset, ensuring it only contains changes made after the most recent intersection.
   Henceforth, references to the document in the_upsi_metadata collection as the metadata document.
   As an example, the metadata document for Alice's database looks like the following:

```
{
  “current_set”: [18, 20, 27],
  “updates_made”: [20, 55]
}
```

In this example, Alice's current_set includes the values 18, 20, and 27, while the updates_made field reflects recent changes, indicating that 20 has been removed and 55 added. After the intersection is computed, the updates_made field will be cleared and ready to track future changes.

### How and When the Metadata Document Gets Updated

Updating current_set. The current_set field is updated whenever a user makes changes to their database. This includes inserting a new document, deleting an existing one, or updating an existing document. After any such modification to the database, evaluate whether the change affects the metadata documents. Specifically, if an element needs to be added to or removed from the set underlying the user's database, adjust the current_set field accordingly. Note that not every document insertion or deletion leads to changes in the current_set. For example, if a new document is added with a value that already exists in the current set, no changes are needed. Similarly, if a document is deleted but the value it contained still exists in other documents within the database, that value remains in the current_set.

Updating updates_made. Whenever an element is added to or removed from the current_set, check whether this element is already in the updates_made set. If it is present, it is removed from updates_made; if it is not present, it is added. This process ensures that if an element is both added and deleted within the same epoch (i.e., between two intersections), these changes effectively cancel each other out and do not need to be communicated to the other party. Let A represent the set of elements added, and D the set of elements removed, during the current update operation for the UPSI-DD field field_name.

```
function updateMetadataDocuments(field_name, A, D):
  let U be an empty set
  let metadataDoc = db._upsi_metadata.findOne( );
  // Step 1: Update the current_set document
  for each element x in A:
    if x not in metadataDoc.current_set:
      add x to metadataDoc.current_set
          add x to set U
  for each element x in D:
    // Check if x still exists in the database before removing
    if not db.collection.findOne({ field_name: x }):
      remove x from metadataDoc.current_set
            add x to set U
  // Step 2: Update the updates_made document
  for each element x in U:
        if x in metadataDoc.updates_made:
          remove x from metadataDoc.updates_made
        else:
          add x to metadataDoc.updates_made
```

Alice's Example. Revisit the example of Alice from above:

### Alice's Database:

Document D11: {age: 18, insurance: “cigna” }
Document D12: {age: 20, insurance: “cigna” }
Document D13: {age: 18, insurance: “aetna” }
Document D14: {age: 27, insurance: “aetna” }
   Initially, her metadata document looks like this:

```
{
  current_set: [18, 20, 27],
  updates_made: [ ]
}
```

Suppose Alice updates Document D13 by changing the age from 18 to 55. This update affects the metadata as follows:
1. Since Alice changed the age from 18 to 55, the value 18 potentially needs to be removed from the current_set, and 55 possibly needs to be added.
2. Since the database contains another document (D11) with age 18, the value 18 is not removed from the current_set.
3. Since 55 is not already in current_set, it is added to current_set.
4. Since 55 is not already in updates_made, it is also added to updates_made.
   After these changes, Alice's collection looks like the following:

### Alice's Database:

Document D11: {age: 18, insurance: “cigna” }
Document D12: {age: 20, insurance: “cigna” }
Document D13: {age: 55, insurance: “aetna” }
Document D14: {age: 27, insurance: “aetna” }
   Alice's metadata document:

```
{
  “current_set”: [18, 20, 27, 55],
  “updates_made”: [55]
}
```

Now suppose Alice deletes Document D13. The metadata updates as follows:
Since no other document contains the age 55, 55 is removed from current_set.
Since 55 was already in updates_made, it is also removed from updates_made.
   After this deletion, her metadata document looks like this:

```
{
  “current_set”: [18, 20, 27],
  “updates_made”: [ ]
}
```

This process highlights how the metadata document dynamically reflects the current state of the database while efficiently managing updates and deletions.

### Modifying Existing Operators for UPSI-DD

As noted above, to ensure the correctness of the metadata documents in a UPSI-enabled database, modifications to the database need to trigger corresponding updates to the metadata. Therefore, proposed for some embodiments is a wrapper around existing MongoDB update operators, referred to as the upsi_xxx counterparts. These wrappers ensure that the metadata updates occur automatically whenever a user modifies the database. Similar wrappers can be used in the context of other document based database systems as well as other dynamic schema database systems.

In a UPSI-enabled database, users replace their use of original database operators with these upsi_xxx counterparts. By doing so, the complexities of managing the underlying metadata are handled seamlessly in the background. These wrappers follow a standardized stencil for update operators, which is illustrated using the modifyo operator as an example:

function upsi_modify(arg):
1. Perform the Original Operation: The upsi_modify( ) wrapper first executes the original modify(arg) operation to apply the intended changes to the database.
2. Compute Added Elements (Set A): After the modification, the wrapper identifies the set of elements being added to the database due to this operation. This set is denoted as A.
3. Compute Deleted Elements (Set D): Similarly, the function determines the set of elements being removed from the database, referred to as D.
4. Update Metadata Documents: Finally, the upsi_modify( ) function updates the metadata documents by executing the updateMetadataDocuments(field_name, A, D) function, where field_name is the name of the UPSI-DD field.

### Example Implementation: Intersection-Time Metadata Tracking

Example approaches can involve incrementally tracking updates. A more efficient alternative to incremental metadata tracking is intersection-time metadata tracking. In this approach, the parties compute the updates made since the last intersection only at the time of the next intersection. Rather than risking continuously updating metadata with each database change, the parties project the values in the UPSI-DD field as a set right before they intend to perform an intersection. They then compare this current set with the set from the last intersection. Specifically, they calculate the set of elements added by performing a set difference (current set\last set) and the set of elements deleted by performing (last set\current set). For metadata, each party maintains a minimal record by storing only the old set from the last intersection. This is done by creating a metadata collection, _upsi_last_set, containing a single document with an array field called elements, which stores the elements of the set at the time of the previous intersection. When a new intersection is computed, the elements field is simply updated with the elements of the currently projected set. An example benefit of some embodiments include that it eliminates the overhead on database updates, consolidating the work into the intersection operation itself. This reduces contention and improves overall system performance.

The repeatedPrivateMatch Operator in MQL

Above embodiments describe how existing database update operations can be modified to work seamlessly with intersection operations on a UPSI-enabled database—for example, with MongoDB. Other examples can be extended as discussed to other document based database and/or dynamic schema database implementations. To provide additional implementation examples, a new operator for the MongoDB Query Language (MQL) is described which would enable the parties to repeatedly compute intersections.

For UPSI-DD, the repeatedPrivateMatch operator is introduced in MQL to facilitate secure and efficient computation of intersections across two datasets. This operator handles the complexities of repeated intersections by implementing cryptographic UPSI protocols in the background.

As an example, consider a case where Alice wants to repeatedly compute intersections of collectionA.fieldA with Bob's collectionB.fieldB. She would execute the following command, wherepermissionLink is the secure link she previously established with Bob on collectionA.fieldA and collectionB.fieldB: intersection=permissionLink.repeatedPrivateMatcho.

Behind the scenes, the repeatedPrivateMatch operator implements an epoch of UPSI-DD protocol. Specifically, the pseudocode for the repeatedPrivateMatch operation is as shown in FIG. 7A-B. The example assumes, without loss of generality, that Alice executes the operation and that we are using Intersection-Time Metadata Tracking to track updates.

### Example Emulation

The repeatedPrivateMatch( ) operator implements an (epoch of the) UPSI protocol (OSX-instantiated UPSI framework) by using emulation, a technique that helps adapt cryptographic UPSI protocols into MongoDB queries and updates. This allows intersection operations to be executed using a database's (e.g., MongoDB's) native capabilities while preserving the security guarantees of the UPSI protocol. Specifically, encrypted data structures, such as an encrypted multi-map, and the algorithms used to query them are respectively translated into, for example, MongoDB-friendly document databases and MQL operators. This example approach ensures that the intersection operations defined by the UPSI protocol are seamlessly integrated into MongoDB's infrastructure.

In this section, an outline the process of emulating the UPSI protocol is provided. Rather than describing the entire emulation in one step, the description breaks it down into multiple stages. Begin with emulating the basic building blocks and then gradually build the emulated protocol on top of them. Recall that the UPSI framework uses the following components: OSX, a PSU protocol, and generic 2PC, with OSX itself utilizing an OKVS. In the first stage, discussed is how to emulate an OKVS, then proceed to the emulation of OSX, and finally, detailed is the emulation of the entire framework.

Storage-level emulation. Note that example does not describe a full emulation but a storage-level emulation. The difference between full and storage-level emulation is that the latter only emulates the data structures of the cryptographic protocol but not its query and update algorithms. In other words, the emulated version requires no modifications to MongoDB's server storage system but uses the new query and update algorithms. Note that it is possible to fully emulate the UPSI protocol, but storage-level emulation results in a more efficient scheme.

### Emulating Oblivious Key-Value Stores OKVS

### RB-OKVS: An OKVS Based on Random Band Matrices

In OSX, instantiated is an Oblivious Key-Value Store (OKVS), using RB-OKVS—an OKVS based on random band matrices. Here's how RB-OKVS functions:
Initialization: The syntax is R₁, R₂←Init(k, λ, n, m, w). During initialization, the algorithm takes in two security parameters: k, the computational security parameter, and A, the statistical security parameter. Additionally, it receives n, the number of labels to be encoded in the OKVS; the encoding size given by m=(1+ϵ)n; and a width parameter w, where w≤m. The algorithm outputs two hash keys R₁ and R₂, each λ-bits long. The first hash function, H₁, maps each label to an integer within the range {1, . . . , m-w}, such that H₁(R₁, [symbol] ) ∈{1, . . . , m−w}. The second hash function, H₂, maps each label to a w-bit string, such that H₂(R₂, [symbol] ) ∈{0, 1}^{w}. Encoding: The encoding algorithm s=Encode({( [symbol] ᵢ, vᵢ)}_{iϵ|n|}, R₁, R₂) takes as input a set of n label-value pairs, denoted as {( [symbol] ₁, v₁), . . . , ( [symbol] ₙ, vₙ)}, along with the hash keys R₁ and R₂. It takes as input a set of n label-value pairs, denoted as {( [symbol] ₁, v₁), . . . , ( [symbol] ₙ, vₙ)}, along with the hash keys R₁ and R₂. It outputs a vector s of size m×1, computed as follows. First, an n×m matrix M is created, where each row i corresponds to a label [symbol] ᵢ. For each i∈[n], H₁ (R₁, [symbol] ᵢ) determines the starting position of a v-bit random band, and H₂(R₂, [symbol] ᵢ) generates the contents of this band. The random band H₂(R₂, [symbol] ᵢ) is then embedded in the row starting at the position determined by H₁(R₁ [symbol] ᵢ), with the remaining positions in the row set to 0. The algorithm then solves for the vector s such that M·s=[v₁, . . . , vₙ]^{T}.
Decoding: In the decoding phase, the decoding algorithm v=Decode(s, [symbol] , R₁, R₂) takes as input the encoded vector s, a query label [symbol] , and the hash keys R₁ and R₂. It uses the same random functions H₁ and H₂ with the keys R₁ and R₂ to reconstruct the starting location H₁(R₁, [symbol] ) of the w-bit random band, and the contents of the band H₂(R₂, [symbol] ). The algorithm then computes the dot product between the w-bit vector H₂(R₂, [symbol] ) and the corresponding w-bit subsequence of s starting at the position H₁ (R₁, [symbol] ). The result v of this dot product is returned as the output.
At a high level, an Oblivious Key-Value Store (OKVS) is considered correct if the Decode function accurately retrieves the value for all labels that are “in” the OKVS. In terms of security, an OKVS must encode n label-value pairs such that an adversary, even when provided with the encoding, cannot reverse-engineer the original input labels-assuming the input values are random. This means that the encoding process is oblivious to the input labels.

### Emulating RB-OKVS

Now describe how embodiments emulate RB-OKVS. To provide context, let's first recall the role of an OKVS in the OSX scheme, which will help clarify the rationale behind our emulation design. In OSX, when a client wishes to update its encrypted set held by the server, it encodes all its updates into a new OKVS and sends this OKVS to the server. Specifically, for the RB-OKVS scheme, the OKVS is represented by the encoded vector s that the client sends to the server. The server then stores this new vector alongside the previously received vectors. Later, when the server needs to check if an element exists in the client's set, it queries (i.e. decodes) all the stored OKVSs (i.e., the vectors) for that element and sends the results to F_{VODPC}.

In order to emulate, the client must convert the encoded vector s into a format that the server can store in a MongoDB database and later decode. Focusing on storage-level emulation rather than full emulation, it is sufficient to emulate the vector s into a MongoDB-compatible format. Emulating the Encode protocol. Emulating the Encode protocol involves the client creating a document that captures both the encoded vector s and the necessary parameters for decoding. Specifically, the client generates a document with an array field called encoding, where each element corresponds to an element of the vector s. Additionally, the client includes a nested field called parameters, which stores all the values needed by the server for decoding. For instance, the document includes nested fields within parameters to convey the values of m, w, R₁ and R₂ The structure of the document for a vector s=[s₁, . . . , sₘ] is as follows:

```
{
  parameters: {
    m: <value>,
    w: <value>,
    R_1: <first hash key>,
    R_2: <second hash key>
  },
  encoding: [<s₁>, <s₂>, ..., <sₘ>]
}
```

When the server receives this document, it creates a new collection called_okvs and stores the document within that collection.

```
// Here set X is a set of label value pairs
function emulateEncodeProtocol(X, m, w, R_1, R_2) {
  // Step 1: Create the encoding vector s using the Encode algorithm of RB-OKVS
  let encodedVector = RBOKVS.Encode(X, R_1, R_2);
  // Step 2: Store each element of the encoded vector in an array
  let encodingArray = [ ];
  for (let i = 0; i < encodedVector.length; i++) {
    encodingArray.push(encodedVector[i]); // Populate the array with vector elements
  }
  // Step 3: Create the parameters object
  // The parameters object will store the values needed for decoding
  let parametersObject = {
    m: m, // Store the value of m
    w: w, // Store the value of w
    R_1: R_1, // Store the first hash key
    R_2: R_2 // Store the second hash key
  };
  // Step 4: Create the document
  // This document contains the parameters and encoding array
  let encodedDocument = {
    parameters: parametersObject, // Embed the parameters object
    encoding: encodingArray // Embed the encoding array
  };
  // Step 4: Send the document to the server
  // The server stores this document in a new collection called _okvs
  sendToServer(encodedDocument);
  // Server-side pseudocode (executed upon receiving the document):
  function sendToServer(document) {
      // Create a new collection called _okvs if it doesn't exist
      if (!db._okvs) {
        db.createCollection(“_okvs”);
      }
    // Store the document in the _okvs collection
    db._okvs.insert(document);
  }
}
```

Emulating the Decode protocol. To decode a label t using the encoded vector stored in the MongoDB collection_okvs, the server would follow the pseudocode: function emulatedDecode(label 1):

// Step 1: Retrieve the document containing the encoded vector and parameters
let doc = db._okvs.findOne( );
// Step 2: Extract the parameters and the encoded vector
let parameters = doc.parameters;
let encodedVector = doc.encoding;
// Step 3: Compute the hash values H1 and H2 for the label ‘l’
let startingPosition = H1(parameters.R1, l); // Computes H1(R1, l)
let randomBand = H2(parameters.R2, l); // Computes H2(R2, l)
// Step 4: Locate the relevant subsequence in the vector ‘s’
let subsequence = encodedVector.slice(startingPosition, startingPosition + parameters.w);
// Step 5: Compute the dot product between the random band and the subsequence
let decodedValue = dotProduct(randomBand, subsequence);
// Step 6: Return the decoded value
return decodedValue;

### Emulating OSX: a Set StE Scheme

In this description, the focus is on emulating OSX, building on the previous emulation of RB-OKVS.

```
Client initiates this
function emulatedInit(1^{k}):
  let K_e = SKE.keygen(1^{k})
  output K_e;
Client initiates this:
function emulatedUpdate(K_e, (X+, X−), (1^{k}, lambda, m, w)):
  let L = X+ U X−
  initialize an empty set X
  for i in |L|:
    v_i = SKE.enc(K_e, 1)
    add (l_i, v_i) to X
  let (R_1, R_2) = RBOKVS.Init(1^{k}, lambda, |L|, m, w)
  RBOKVS.emulateEncodeProtocol(X, m, w, R_1, R_2) // this adds a document in the _okvs
  collection of the server
Server initiates this:
function emulatedSQuery(Xqry):
  initialize an empty set B
  for label l in Xqry:
    initialize an empty set V
    for each document d in db._okvs collection:
      let v = RBOKVS.emulatedDecode(l)
      add v to V
    compute with client (\bot, b) = FVODPC(V; (K_e, 1)), where the server inputs V
and receives a bit b as output and the client inputs its key K_e, and the number 1, and receives
nothing as output
    add b to B
  output B
```

### Emulating the UPSI-DD Protocol

In this section, discussed is the emulation of a full UPSI-DD protocol according to one embodiment. A focus is on emulating Step 3 of the pseudocode for repeatedPrivateMatch described above, which involves emulating the UPSI framework instantiated with OSX. For the sake of completeness, other parts of the pseudocode are included.

To facilitate this process, each party maintains three collections:
1. _upsi_last_set: This collection contains a single document that stores the set of elements present in the data collection at the time of the last intersection. It essentially captures the state of the data collection before any new updates are made.
2. _upsi_last_intersection: This collection also contains a single document, which stores the set of elements that were part of the last computed intersection. This document is crucial for determining which elements have been retained or removed since the last intersection.
3. _okvs: This collection comprises multiple documents, each corresponding to a distinct epoch (i.e., time between two intersections). Every document in this collection emulates an OKVS that encodes both the additions and deletions that the other party has made to their data set since the last intersection up to the current intersection.

These collections work together to track the state and updates of each party's data, allowing for efficient and secure computation of the intersection at each epoch.

wlog, assume Party P_X (Alice) initiates this
function repeatedPrivateMatch((1^{k}, lambda, m_1, w_1)):

| | |
|---|---|
| Alice: | // Alice initiates the UPSI-DD protocol with Bob |
| | permissionedLink.upsiEpochInitiate( ); |

Alice: // Alice computes the sets of elements she added and deleted since the last intersection

let aliceCurrentSet = db.collectionA.distinct(“fieldA”);
let aliceLastSet = db._upsi_last_set.findOne( ).elements;
let aliceAddSet = setminus(aliceCurrentSet, aliceLastSet);
let aliceDeleteSet = setminus(aliceLastSet, aliceCurrentSet);
// she sends her updates to Bob
let K_A = OSX.emulatedInit(1^{k});
OSX.emulatedUpdate(K_A, (aliceAddSet, aliceDeleteSet), (1^{k}, lambda, m_1, w_1)); // this

adds a document in the _okvs collection of Bob

| | |
|---|---|
| Bob: | // Bob computes the sets of elements he added and deleted since the last intersection |
| | let bobCurrentSet = db.collectionB.distinct(“fieldB”); |
| | let bobLastSet = db._upsi_last_set.findOne( ). elements; |
| | let bobAddSet = setminus(bobCurrentSet, bobLastSet); |
| | let bobDeleteSet = setminus(bobLastSet, bobCurrentSet); |
| | // he sends her updates to Alice |
| | let K_B = OSX.emulatedInit(1^{k}); |
| | OSX.emulatedUpdate(K_B, (bobAddSet, bobDeleteSet), (1^{k}, lambda, m_2, w_2)); // this |

adds a document in the _okvs collection of Alice
Alice (and Bob): // Alice queries all the OKVSs for the elements she added in this epoch

let aliceAddSetToIntersection_S1 = OSX.emulatedSQuery(aliceAddSet); // Note this

requires interaction with Bob
Bob (and Alice): // Bob queries all the OKVSs for the elements he added in this epoch

let bobAddSetToIntersection_S2 = OSX.emulatedSQuery(bobAddSet); // Note this requires

interaction with Alice
Alice and Bob: // using a PSU protocol, Alice and Bob compute the set of elements to be added to
the last intersection

let U = PSU(aliceAddSetToIntersection_S1; bobAddSetToIntersection_S2);
// both Alice and Bob have U after the last step

Alice: // Alice computes the intersection of her delete set with the set of elements in her last
intersection

let aliceLastIntersectionSet = db._upsi_last_intersection.findOne( ).elements;
let aliceRemoveSetFromIntersection = intersect(aliceDeleteSet, aliceLastIntersectionSet);

Bob: // Bob computes the intersection of his delete set with the set of elements in his last
intersection

let bobLastIntersectionSet = db._upsi_last_intersection.findOne( ).elements;
let bobRemoveSetFromIntersection = intersect(bobDeleteSet, bobLastIntersectionSet);

Alice and Bob: // using a PSU protocol, Alice and Bob compute the set of elements to be removed
from their last intersection

let W = PSU(aliceRemoveSetFromIntersection, bobRemoveSetFromIntersection);

Alice: // Alice updates her metadata collections

let newIntersectionSet = union(setminus(aliceLastIntersectionSet, W), U);
db._upsi_last_intersection.updateOne( { }, { $set: { elements: newIntersectionSet } };
db._upsi_last_set.updateOne( { }, { $set: { elements: aliceCurrentSet }};
return newIntersectionSet;

Bob: // Bob updates his metadata collections

let newIntersectionSet = union(setminus(bobLastIntersectionSet, W), U);
db._upsi_last_intersection.updateOne( { }, { $set: { elements: newIntersectionSet } };
db._upsi_last_set.updateOne( { }, { $set: { elements: bobCurrentSet }};
return newIntersectionSet;

Alice: // Alice retrieves her documents that have values in the intersection and sends them to Bob

let resultAlice = db.collectionA.find({ “fieldA”: { $in: newIntersectionSet } });

Bob: // Bob retrieves his documents that have values in the intersection and sends them to Alice

let resultBob = db.collectionB.find({ “fieldB”: { $in: newIntersectionSet } });

Alice and Bob: // Alice and Bob exchange their result sets
Alice: // Alice outputs the documents in the intersection

return concat(resultAlice, resultBob);

Bob: // Bob outputs the documents in the intersection

return concat(resultBob, resultAlice);

### Example Proofs For Various Embodiments: Updatable PSI Security Proof (Theorem 1)

Proof Let i=1, 2 and let A be an efficient adversary; construct a simulator S such that

$$Pr [ {Real}_{{Ω}_{UPSI} , i}^{𝒜} ( {1}^{k} ) = 1 ] - Pr [ {Ideal}_{ℱ , ℒ , 𝒮 , i}^{𝒜} ( {1}^{k} ) = 1 ] = negl ( k ) .$$

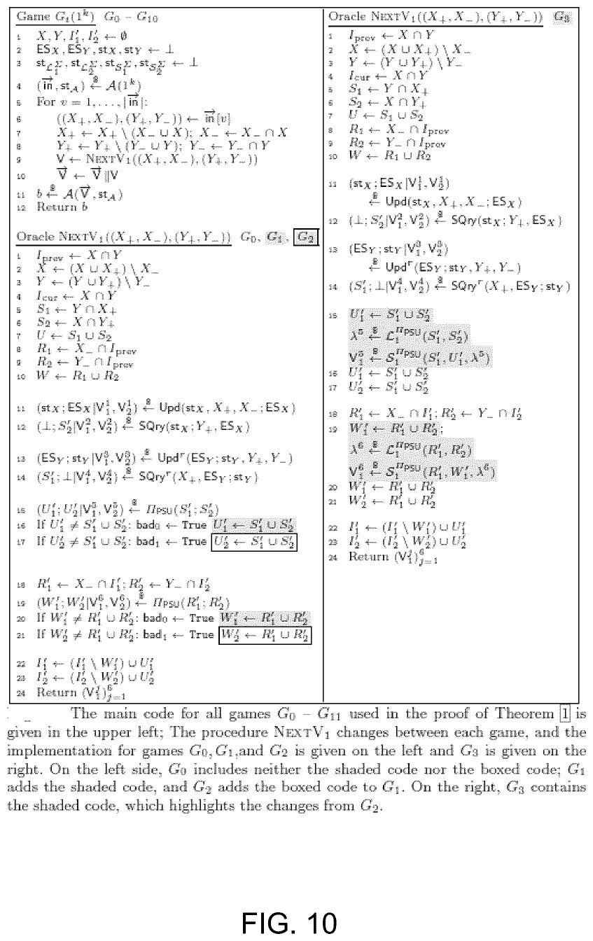

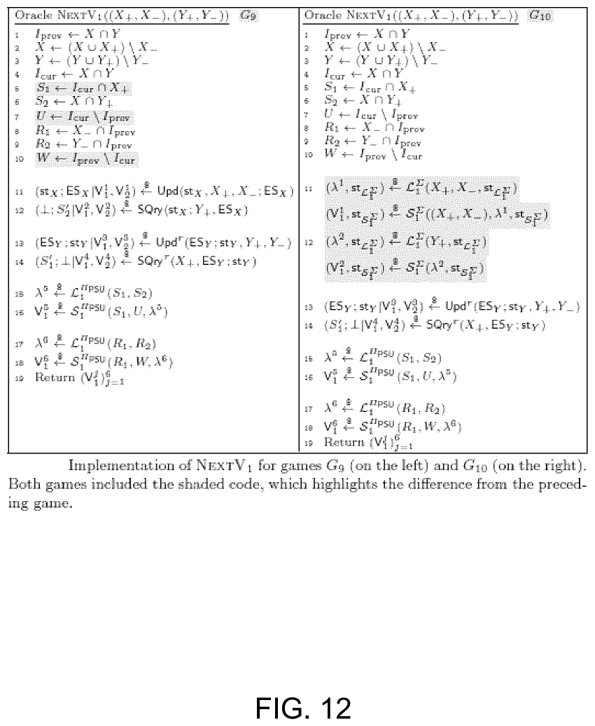

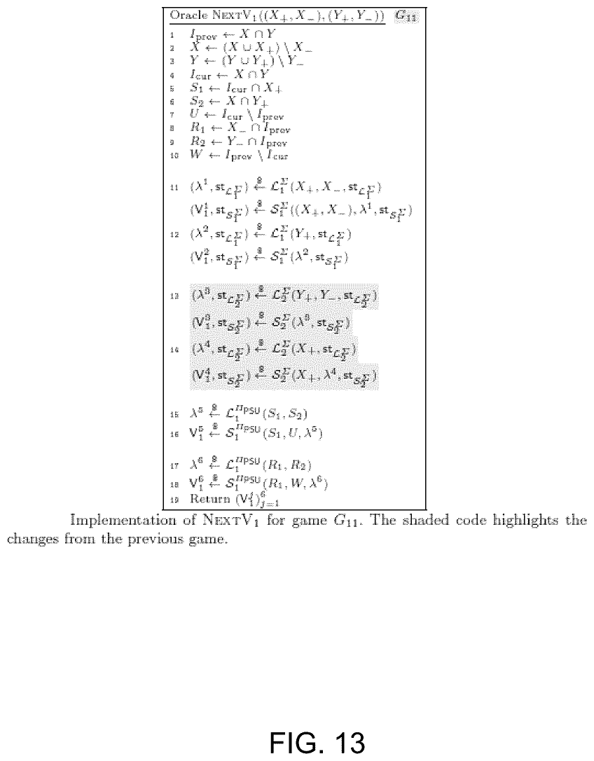

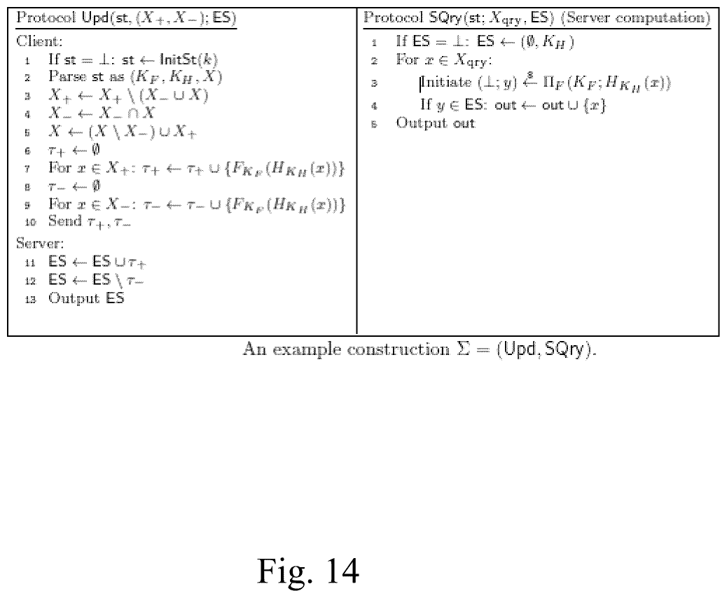

Prove this for i=1; the case of i=2 is symmetric. By the assumed security of Σ and Π_{PSU}, there exist efficient simulators S^{Σ}, S^{Σ} satisfying the conditions in Definition 5 and S^{ΠPSU} satisfying the condition in Definition 1 Since the F_{PSU} is stateless, omit the state arguments in that definition, and assume S^{ΠPSU} is stateless as well. Use the games G₀-G₁₀ in FIGS. 10, 11, 12, and 13. Game_{11,1} G₀. The first game, G₀, which is given on the left side of FIG. 10 computes the same function as Real^{A} (1^{k}) but performs some extra computation. The game consists of a main loop common to all the games (given at the top) and an implementation of the NextV₁ routine (given below). The main loop starts by initializing persistent variables on lines 1-2 that are used in NextV₁ (these include some not in the original game, but they are not used yet). In the NextV₁ subroutine, lines 1-10 compute “ideal” values that are not used in this game, but can be used in future games. The line 16, 17, 20, and 21 perform some extra computation and set flags bad₀, bad₁, but these are not used elsewhere in the game. The rest of the game computes the view of party 1 by performing the computation of each party and executing the appropriate protocols. Writing Gⱼ for the event that Gⱼ outputs 1,

$$Pr [ {Real}_{\prod , 1}^{A} ( {1}^{k} ) = 1 ] = Pr [ {G}_{0} ] . \qquad ( 1 )$$

Game G₁. The next game G₁ adds the shaded code on lines 16, and 20. Since G₀ and G₁ are

$$Pr [ {G}_{0} ] - Pr [ {G}_{1} ] \leq Pr [ {B}_{1} ] , \qquad ( 2 )$$

where B₁ is the event that G₀ sets the variable bad₀. Claim that since Π_{PSU} is secure

$$Pr [ {B}_{1} ] = negl ( κ ) . \qquad ( 3 )$$

Use a reduction to the L^{ΠPSU}-security of I_{PSU} for the first party. The reduction runs A to get its input vector \vec{in} and state. The reduction then simulates the computation of the game until line 16 or 19, at which point it can compute a pair of inputs for its own game (which will be either 2pcReal Π_{PSU,1} or 2pcideal_{FPSU},L1Πpsu, S₁Π^{psu},1). It then continues the simulation assume that bad₀ was not set, i.e. that U′₁=S′₁∪S′₂ or W′=R′₁ ∪R′₂. It then submits its input vector to its own game and receives V out. It ignores V and checks if the sets in out are indeed equal to the appropriate values. If one is incorrect, it outputs 1, and otherwise it outputs 0.

In the game 2pcRealn_{Π}_{_{PSU,1}}, this reduction perfectly simulates G₀ until the bad₀ is set, and outputs 1 in this case (note that the simulation may be incorrect afterwards). On the other hand, in 2pcIdeal F_{PSU}, L₁ Π_{PSU,1} this reduction outputs 1 with probability 0. This implies the reduction has advantage exactly equal to Pr[B₀] and hence this probability is negligible. This establishes (3). Game G₂. The next game adds the boxed code on lines 17 and 21. By a nearly identical argument as the previous transition,

$$Pr [ {G}_{1} ] - Pr [ {G}_{2} ] = negl ( κ ) . \qquad ( 4 )$$

The only difference is reduction to the security of Π_{PSU} for the second party instead of the first. Game G₃. The next game G₃ is given on the right of FIG. 1^{k}0; The line numbers are consistent between G₃ and G₂. There are two types of changes in this game: First, lines 16, 17, 20, and 21 have been collapsed to always compute the corresponding values, which does not change the logic of the code. More substantially, lines 15 and 19 replace protocol runs with the computation of ideal func— tionalities, leakage, and simulators. Claim that, by the L₁^{ΠPSU}-security of Π_{PSU},

$$Pr [ {G}_{2} ] - Pr [ {G}_{3} ] = negl ( κ ) . \qquad ( 5 )$$

This is proved via a straightforward reduction. One runs A to get its input vector \vec{in}, the reduction creates its own input vector by simulating the game directly as in the reduction above, obtaining

$$\text{?}$$

$$\text{?} \text{indicates text missing or illegible when filed}$$

$$\text{?}$$

$$\text{?} \text{indicates text missing or illegible when filed}$$

and from its own game. Note that the previous transitions to G₂ were used for the correctness of this reduction, since it must assume that

$${{U}^{′}}_{1} , {{U}^{′}}_{2} , {{W}^{′}}_{1} , {{W}^{′}}_{2}$$

were computed itself (the reduction can do, following lines 16, 17, 20 and 21) and not by the protocols (which must be computed by the game and not itself). This gives (6).

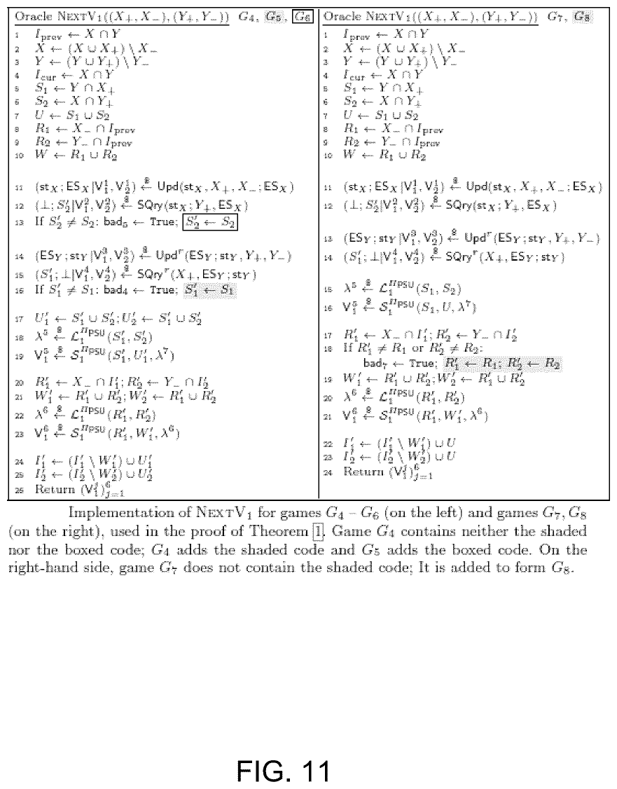

Game G₄. The next game G₄ on the left of FIG. 11 does not include any of the boxed or highlighted code (the line numbers are also not consistent with the previous game). Compared to G₃, it reorders code within the “paragraphs” separated by blank lines without affecting the computation. It also adds conditional statements on lines 13 and 16, but these only set flags bad₄ and bad₅ and do not change the function computed by the game. Thus, G₄ is exactly the same random variable as G₃ and

$$Pr [ {G}_{4} ] = Pr [ {G}_{3} ] . \qquad ( 6 )$$

Game G₅. Next, G₅ adds the shaded code on line 16. Since G₄ and G₅ are “identical-until-bad”,

$$Pr [ {G}_{4} ] - Pr [ {G}_{5} ] \leq Pr [ {B}_{4} ] , \qquad ( 7 )$$

where B₄ is the event that bad₄ is set to true in G₄. We claim that, by the correctness of Σ,

$$Pr [ {B}_{4} ] = negl ( κ ) . \qquad ( 8 )$$

To prove this, construct an efficient adversary A₄ such that Pr[Cor^{A4}(1^{k}) 1] Pr[B₄].

$$\vec{op} ← ε$$

$$For j = 1 , … , \vert \vec{in} \vert :$$

$$( ( {X}_{+} , {X}_{-} ) , ( {Y}_{+} , {Y}_{-} ) ← \vec{in} [ j ]$$

$$\vec{op} ← \vec{op} ‖ ( {Y}_{+} , {Y}_{-} ) ‖ ( {X}_{+} )$$

In other words, for each pair of inputs ((X₊, X₋), (Y₊, Y₋)), it creates an update operation with (Y₊, Y₋) followed by a query operation with X₊. By construction,

$$\text{?} ( {1}^{k} ) = 1$$

$$\text{?} \text{indicates text missing or illegible when filed}$$

with probability Pr[B₄], showing this value is negligible. Once again, the simulation is only correct until the first bad event, but the claim still holds.

Game G₆. The next game G₆ adds a similar reassignment after bad₅ is set to true on line 13, and similar to before:

$$Pr [ {G}_{5} ] - Pr [ {G}_{6} ] \leq Pr [ {B}_{5} ] , \qquad ( 9 )$$

where B₅ is the event that bad₅ is set to true in G₅. A similar argument to the previous transition shows that

$$Pr [ {B}_{5} ] = negl ( κ ) . \qquad ( 10 )$$

Game G₇. Consider G₇, on the right side of FIG. 11 (without the shaded code). This game consolidates some code but computes the same random variable as G₇. In particular, it does the following:
Lines 13 is removed, and later references to S₂_{₂} are replaced with references to S₂.
Lines 16 is removed, and later references to S′₁ instead use S₁.
Line 17 is deleted, and later usage of U′₁ and U′₂′ is replaced by U. These values are equal since S′₁′=S₁ and S₂=S₂.

After these changes, G₇ adds a new (inconsequential) check on its line 18 that does not include the shaded code.

$$Pr [ {G}_{7} ] = Pr [ {G}_{6} ] . \qquad ( 11 )$$

Game G₈. The next game reassigns the values of R′₁, R′₂ on line 18. As before,

$$Pr [ {G}_{7} ] - Pr [ {G}_{8} ] \leq Pr [ {B}_{7} ] , \qquad ( 12 )$$

where B₇ is the event that G₇ sets bad₇. We claim that

$$Pr [ {B}_{7} ] = 0. \qquad ( 13 )$$

Prove this by induction on the number of iterations₁ of₁ the₂ main loop₂ (i.e. the “for” loop on line of the main procedure in upper left of FIG. 10). The inductive claim is that, in just before the start of each iteration of NextV₁, we have I₁′=I′₁=X ∩Y. This implies the claim that Pr[B₇]=0, since if the inductive claim holds clearly R′₁′=R₁ and R′₂′=R₂ in the iteration. For the base of the induction, before the first iteration we have that I′₁=I′₂=Ø=X ∩Y based on the variables set in the main procedure before the loop starts. For the inductive step, the claim holds for one iteration; we will show that it holds for the next iteration as well.

The current iteration updates X to X_{new}=(X∩X₊)X₋ and Y to Y_{new}=(Y∩Y₊) Y₋. By the inductive hypothesis, it also updates I′₁ and I′₂ to I′₁=(X ∩Y)\W′₁ ∩U and I′₂=(X ∩Y)\W′₂ ∪ U Show that

$$( X ⋂ Y ) \backslash {W}_{i}^{′} ⋃ U = {X}_{new} ⋂ {Y}_{new}$$

for i=1, 2. This follows by elementary set algebra:

$$\begin{matrix}( X ⋂ Y ) \backslash {W}_{i}^{′} ⋃ U = ( X ⋂ Y ) \text{\textbackslash (} {R}_{1}^{′} ⋃ {R}_{2}^{′} ) ⋃ U \\ = ( X ⋂ Y ) \text{\textbackslash (} ( {X}_{-} ⋂ ( X ⋂ Y ) ⋃ ( {Y}_{-} ⋂ ( X ⋂ Y ) ) ⋃ U \\ = ( X ⋂ Y ) \text{\textbackslash (} ( {X}_{-} ⋃ {Y}_{-} ) ⋂ ( X ⋂ Y ) ) ⋃ U \\ = ( X ⋂ Y ) \text{\textbackslash (} {X}_{-} ⋃ {Y}_{-} ) ⋃ U \\ = ( {X}_{new} ⋂ {Y}_{new} ) \text{\textbackslash (} {X}_{+} ⋃ {Y}_{+} ) ⋃ U \\ = ( {X}_{new} ⋂ {Y}_{new} ) \text{\textbackslash (} {X}_{+} ⋃ {Y}_{+} ) ⋃ ( {X}_{new} ⋂ {Y}_{+} ) ⋃ ( {Y}_{new} ⋂ {X}_{+} ) \\ = {X}_{new} ⋂ {Y}_{new} .\end{matrix}$$

The second equality uses the inductive hypothesis to replace R′1, R′2, the sixth equality uses the assumption that X₊∩X₋=Y₊∩Y₋=Ø, and the fifth equality uses the identity

$$( X ⋂ Y ) \text{\textbackslash (} {X}_{-} ⋃ {Y}_{-} ) = ( {X}_{new} ⋂ {Y}_{new} ) \text{\textbackslash (} {X}_{+} ⋃ {Y}_{+} )$$

which can be seen via

$$\begin{matrix}{X}_{new} ⋂ {Y}_{new} \text{\textbackslash (} {X}_{+} ⋃ {Y}_{+} ) = ( ( X \backslash {X}_{-} ) ⋃ {X}_{+} ) ⋂ ( ( Y \backslash {Y}_{-} ) ⋃ {Y}_{+} ) ) \text{\textbackslash (} {X}_{+} ⋃ {Y}_{+} ) \\ = ( X \backslash {X}_{-} ) ⋂ ( Y \backslash {Y}_{-} ) \\ = ( X ⋂ Y ) \text{\textbackslash (} {X}_{-} ⋃ {Y}_{-} ) .\end{matrix}$$

This completes the proof of (13).

Game G₉. The next game removes lines 19-21 and replaces all usage of R′1,R′2 with R₁, R₂ respectively, usage of W′₁, W′₂ with W and usage of. In the resulting game, I′₁, I′₂ are no longer used, so lines 24-25 are also removed. The game also changes the three shaded lines to compute S₁, U, and Win a way that will enable simulation. Claim that these always result in the same values, so

$$Pr [ {G}_{9} ] = Pr [ {G}_{8} ] . \qquad ( 14 )$$

Consider S₁, U and W individually in order. Previously, S₁ was set to Y∩X₊, and now it is set to I_{cur} ∩X₊=(X ∩Y)∩X₊; These are equal because at this point in the code we always have X₊⊆X (this again relies on X₊ and X₋ being disjoint). Next, U is now computed as I_{cur} \Iₚᵣₑᵥ instead of S₁ ∪S₂. To see that these are equal, take the values X, Y at the start of the loop and write X_{new}=((X∪X₊)\X₋) and Y_{new}=((Y∪Y₊) Y₋). Then the following hold:

$${S}_{1} ⋃ {S}_{2} = ( {Y}_{new} ⋂ {X}_{+} ) ⋃ ( {X}_{new} ⋂ {Y}_{+} )$$

$${I}_{cur} \backslash {I}_{prev} = {X}_{new} ⋂ {Y}_{new} \text{\textbackslash (} X ⋂ Y ) .$$

An elementary argument shows these are equal: For one direction, suppose αϵX_{new} ∩Y_{new}(X ∩Y). Then αϵX₊∪Y₊, so αϵY_{new} n X₊ or αϵX_{new} ∩Y₊. For the other direction, suppose without loss of generality that αϵY_{new} ∩X₊. Since αϵX₊, α∉X and αϵX_{new}, αϵ(X_{new} ∩Y_{new})\(X ∩Y) as desired. Finally, Wis computed as Iₚᵣₑᵥ \I_{cur} instead of R₁ ∪R₂. This are seen to be equal by yet more elementary set theory: We have

$$\begin{matrix}{R}_{1} ⋃ {R}_{2} = ( {X}_{-} ⋂ ( X ⋂ Y ) ) ⋃ ( {Y}_{-} ⋂ ( X ⋂ Y ) ) \\ = ( X ⋂ Y ) ⋂ ( {X}_{-} ⋃ {Y}_{-} )\end{matrix}$$

$$and {I}_{prev} \backslash {I}_{cur} = ( X ⋂ Y ) ∖ ( ( ( X ⋃ {X}_{+} ) ∖ {X}_{-} ) ⋂ ( ( Y ⋃ {Y}_{+} ) ∖ {Y}_{-} ) ) .$$

By assumption, X₊ is disjoint from X and Y₊ is disjoint from Y, so this is equal to

$$( X ⋂ Y ) \text{\textbackslash (} ( X \backslash {X}_{-} ) ⋂ ( Y \backslash {Y}_{-} ) ) .$$

which is equal to (X ∩Y) ∩(X₋∪Y₋), as desired. This establishes (14). Game G₁₀. This game only changes lines 11 and 12 (line numbers are consistent with the previous game). On line 11, instead of running the Upd^{r} protocol to generate an updated ES_{γ · and v}³, it uses the leakage function and simulator. A similar change is made on line 12. We claim that by the L^{Σ}-security of Σ,

$$Pr [ {G}_{9} ] - Pr [ {G}_{10} ] = negl ( k ) . \qquad ( 15 )$$

This is proved via a straightforward reduction to the server's security guaranteed by Σ. The adversary can simulate the entire game except for lines 11 and 12. Since the output values ES_{X,}_{₂} S′ are not used anywhere else, there is no correctness issue with the non-adaptive adversary computing all of the input values up front.

Game G₁₁. This game makes a transition similar to the previous one, on lines 13 and 14. Once Again the reduction is straightforward (this time to the client's security).

$$Pr [ {G}_{10} ] - Pr [ {G}_{11} ] = negl ( k ) . \qquad ( 16 )$$

Complete the game hopping by observing that

$$Pr [ {G}_{11} ] = Pr \vert {Ideal}_{{F}_{UPSI} , ℒ , S , 1}^{A} ( {1}^{k} ) = 1 \vert . \qquad ( 17 )$$

This can be seen by pasting in the code of F_{UPSI} along with L and S from the theorem statement into Ideal, which produces a game equivalent to Gr. The only differences are that some values^{□} are computed by more than algorithm (but in the same way), and the values are computed in a different, ultimately equivalent, order. The theorem now follows by collecting (1)-(17) and observing that the sum of a constant number of negligible functions is negligible.

### Example ESX Proof (Lemma 2)

Proof For the first invariant, observe that during an epoch, each operation adds one item to the tree, and possibly deletes some previous ones. While control over the exact time at which the previous items are deleted is not possible, it is known that all deletes from the previous epoch will be deleted by the end of the epoch, and each such delete will remove two items from the tree. Thus each epoch, in the worst case, increases the number of elements by the length of the current epoch divided by 8 and decreases by double the number of deletes in the previous epoch. The claim then follows. Prove the second invariant and third invariant together by induction. They both clearly hold at the start, when the first epoch has h₀=h₁=0 and there are no items stored in the tree. Now suppose the invariants hold at the end of some epoch with a tree of height h During the next epoch, there are three possibilities: h is either increased, decreased, or unchanged. We consider these separately:
1. If h is decreased, then h₀=h, h₁=h=1 during this epoch. Since this epoch will decrease h, the number of items in the tree is at most 2^{h}/8 at the start of the epoch. The next epoch will have length 2^{h-1}/8=2^{h}/16, and hence add that many items to tree.
   To establish the second invariant, we must show that the load never exceeds 1^{min{h}^{₀}^{, h}^{₁}^{}}=2^{h}/2, and to establish the third, we must show that the load is at most 2^{h1}^{^{−1}}=2^{h}/4 at the end of the epoch. But the load on the tree never exceeds

$${2}^{h} / 8 + {2}^{h} / 16 < {2}^{h} / 4 ,$$

which shows that both invariants hold for the case of a decreasing epoch.

### Numbered Embodiments

1. A distributed database system, comprising: at least one processor, operatively connected to a memory, the at least one processor configured to: execute a dynamic structured encryption scheme including: transformation of plaintext data into a structured encryption format; instantiation of an updatable set datatype with the structured encryption format; and cryptographic operations configured to: perform updates on a first party encrypted data set by the first party maintained by a second party, perform updates on a second party encrypted data set by the second party maintained by the first party, and execute queries on the other party's encrypted data set to return an intersection of the first party and second party encrypted data sets based on query target.
2. A distributed database system, comprising: at least one processor, operatively connected to a memory, the at least one processor configured to: manage execution of a dynamic structured encryption scheme including: transformation of plaintext data into structured encryption format, including an updateable set datatype; manage execution of cryptographic protocols on the updateable set datatype including at least two parties, managing execution comprising: a first protocol executed to query, wherein a first party accepts as input a state definition and a query set, a second party accepts as input an encrypted set, and the first party outputs an output set based on the intersection of the query set and encrypted set; and a second protocol executed for updates, wherein the first party inputs a state definition and paired sets reflecting additions and deletes respectively, and the second party inputs an encrypted set.
3. A distributed database system, comprising: at least one processor, operatively connected to a memory, the at least one processor configured to: execute a dynamic structured encryption scheme including: transformation of plaintext data into structured encryption format; instantiation of an updateable set datatype; cryptographic operations guaranteed to provide minimal leakage to adverse parties, the cryptographic operations when executed configured to: perform updates on a first party encrypted data set by the first party maintained by a second party, perform updates on a second party encrypted data set by the second party maintained by the first party, and execute server side queries on the other party's encrypted data sets to return an intersection of the first party and second party encrypted data sets based on a query target.
4. A distributed database system, comprising: at least one processor, operatively connected to a memory, the at least one processor configured to: execute a dynamic encryption scheme for set data structures with server side querying including: transformation of plaintext data into a structured encryption format; an oblivious key-value store (OKVS) for storing encrypted data in a plurality of OKVS data structures; a vector oblivious decrypt and parity check (VODPC) function; cryptographic operations configured to provide low leakage security, wherein the cryptographic operations when executed are configured to: execute server side querying on data in the structured encryption format based on operations that: for each element of encrypted membership query (e.g., X_{qry}) query the plurality of OKVS data structures to retrieve ciphertexts, invoke the VODPC function configured to determine a number of ciphertexts that decrypt to a system defined constant value (e.g., 1), and output parity information on a count of values that match the constant value.
5. The system of any of the preceding system embodiments, wherein the at least one processor is configured to execute the dynamic structured encryption scheme to further include operations configured to add and remove data from an intersection data set defined on existing intersection of the first party and second party data sets.
6. The system of any of the preceding system embodiments, wherein the at least one processor is configured to execute the dynamic structured encryption scheme, wherein the operations to add and remove take as input the first party and second party encrypted data sets and outputs the union of the first party and second party encrypted data sets to both parties.
7. The system of any of the preceding system embodiments, wherein the operations to add and remove are configured to enable set updates to vary in size or enable set updates to be malformed.
8. The system of any of the preceding system embodiments, wherein the first party is a client system.
9. The system of any of the preceding system embodiments, wherein the first party is a server system.
10. The system of any of the preceding system embodiments, wherein the cryptographic operations are executed to include oblivious pseudo random function (PRF) and two-party computation.
11. The system of any of the preceding system embodiments, wherein the cryptographic operations are executed based on symmetric-key primitives, and maintains security to limit leakage to query equality.
12. The system of any of the preceding system embodiments, wherein the at least one processor is configured to transform plaintext data into tree-based structure incorporating oblivious random access machine functionality (ORAM).
13. The system of any of the preceding system embodiments, wherein a size of the tree-based structure is configured to grow and shrink based on operations executed in epochs.
14. The system of any of the preceding system embodiments, wherein the at least one processor is configured to update the size of the tree-based structure based on a simulated load.
15. The system of any of the preceding system embodiments, wherein the first party is a client system.
16. The system of any of the preceding system embodiments, wherein the first party is a server system.
17. The system of any of the preceding system embodiments, wherein the cryptographic operations are guaranteed to provide minimal leakage to adverse parties, wherein minimal leakage limits leakage to a size of the updates during execution.
18. The system of any of the preceding system embodiments, wherein the operations to perform updates are configured to enable set updates to vary in size.
19. The system of any of the preceding system embodiments, wherein the at least one processor is configured to manage encrypted binary trees wherein each node holds a number of slots that can real or padding values.
20. The system of any of the preceding system embodiments, wherein the at least one processor is configured to control a size of the encrypted binary trees based on epochs.
21. The system of any of the preceding system embodiments, wherein the at least one processor identifies an end of a respective epoch based on an update operation that evaluates as true.
22. The system of any of the preceding system embodiments, wherein the at least one processor manages binary tree size based on growing the binary tree which is configured to add a level to the binary such that the new level is defined with two leaves, shrinking the binary tree based on removing one leaf per operation, or maintain the binary tree.
23. The system of any of the preceding system embodiments, wherein the at least one processor is configured to limit leakage of information during a plurality of epochs based on a simulated load.
24. The system of any of the preceding system embodiments, wherein the at least one processor is configured to generate the simulated load based on an upper bound of a number of non-padding items represented by additions or deletions.
25. The system of any of the preceding system embodiments, wherein the at least one processor is configured to execute the cryptographic operations such that arbitrary deletes and inserts are managed in respective epochs and execution occurs with poly-logarithmic overhead.
26. Thes system of any of the preceding system embodiments, wherein the at least one processor is configured to execute the cryptographic operations with the poly-logarithmic overhead in computation and communication complexity.
27. The system of any of the preceding system embodiments, wherein the at least one processor is configured to enable query and update protocols in constant rounds.
28. The system of any of the preceding system embodiments, wherein the at least one processor is configured to execute the cryptographic operations to enable determination for updateable private set intersection having non-reactive functionality.
29. The system of any of the preceding system embodiments, wherein the first party is a client system or a server system.
30. Thes system of any of the preceding system embodiments, wherein the operations to perform updates are configured to enable set updates to vary in size.
31. The system of any of the preceding system embodiments, wherein the least one processor is configured to generate an OKVS data structure for an update to the set data structure.
32. The system of any of the preceding system embodiments, wherein labels in the OKVS data structure are elements of the OKVS being updated.
33. The system of any of the preceding system embodiments, wherein the at least one processor is configured to define a value for the label as a ciphertext encoding a constant.
34. The system of any of the preceding system embodiments, wherein the at least one processor is configured to encode additions and deletions by a special ciphertext for a system defined constant value (e.g., 1).
35. The system of any of the preceding system embodiments, wherein the special ciphertext is predefined on the system to specify that an update (e.g., add, delete, etc.) operation was performed on a label.
36. The system of any of the preceding system embodiments, wherein the at least one processor is configured to maintain low leakage so that leakage to the client is a number of queries the server made and there is no query leakage to the server.
37. A computer implemented method for executing any of the preceding system embodiments.38. A non-transitory computer-readable medium containing instructions that when executed by at least one processor cause the at least one processor to perform a method for executing any of the preceding system embodiments or preceding computer implemented method embodiments.

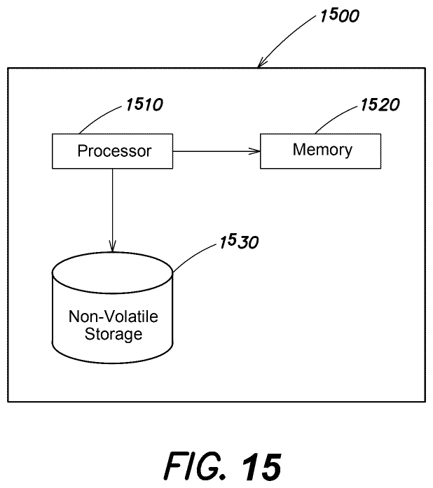

FIG. 15 is a block diagram of an example computer system that is improved by implementing the functions, operations, and/or architectures described herein. Modifications and variations of the discussed embodiments will be apparent to those of ordinary skill in the art and all such modifications and variations are included within the scope of the appended claims. Additionally, an illustrative implementation of a computer system 1500 that may be used in connection with any of the embodiments of the disclosure provided herein is shown in FIG. 15. The computer system 1500 may include one or more processors 1510 and one or more articles of manufacture that comprise non-transitory computer-readable storage media (e.g., memory 1520 and one or more non-volatile storage media 1530). The processor 1510 may control writing data to and reading data from the memory 1520 and the non-volatile storage device 1530 in any suitable manner. To perform any of the functionality described herein (e.g., image reconstruction, anomaly detection, etc.), the one or more processor 1510 may execute one or more processor-executable instructions stored in one or more non-transitory computer-readable storage media (e.g., the memory 1520), which may serve as non-transitory computer-readable storage media storing processor-executable instructions for execution by the one or more processors 1510.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract datatypes. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described herein) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

In other embodiments, various ones of the functions and/or portions of the flows discussed herein can be executed in different order. In still other embodiments, various one of the functions and/or portions of the flow can be omitted, or consolidated. In yet other embodiments, various one of the functions and/or portions of the flow can be combined, and used in various combinations of the disclosed flows, portions of flows, and/or individual functions. In various examples, various one of the screens, functions and/or algorithms can be combined, and can be used in various combinations of the disclosed functions.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A distributed database system, comprising:
at least one processor, operatively connected to a memory, the at least one processor configured to:
execute a dynamic structured encryption scheme including:
transformation of plaintext data into a structured encryption format;
instantiation of an updatable set datatype with the structured encryption format; and
cryptographic operations configured to:
perform updates on a first party encrypted data set by the first party maintained by a second party,
perform updates on a second party encrypted data set by the second party maintained by the first party, and
execute queries on the other party's encrypted data set to return an intersection of the first party and second party encrypted data sets based on query target.

2. The system of claim 1, wherein the at least one processor is configured to execute the dynamic structured encryption scheme to further include operations configured to add and remove data from an intersection data set defined on existing intersection of the first party and second party data sets.

3. The system of claim 2, wherein the at least one processor is configured to execute the dynamic structured encryption scheme, wherein the operations to add and remove take as input the first party and second party encrypted data sets and outputs the union of the first party and second party encrypted data sets to both parties.

4. The system of claim 3, wherein the operations to add and remove are configured to enable set updates to vary in size or enable set updates to be malformed.

5. The system of claim 1, wherein the first party is a client system.

6. The system of claim 1, wherein the first party is a server system.

7. The system of claim 6, wherein the cryptographic operations are executed to include oblivious pseudo random function (PRF) and two-party computation.

8. The system of claim 1, wherein the cryptographic operations are executed based on symmetric-key primitives, and maintains security to limit leakage to query equality.

9. The system of claim 1, wherein the at least one processor is configured to transform plaintext data into tree-based structure incorporating oblivious random access machine functionality (ORAM).

10. The system of claim 9, wherein a size of the tree-based structure is configured to grow and shrink based on operations executed in epochs.

11. The system of claim 10, wherein the at least one processor is configured to update the size of the tree-based structure based on a simulated load.

12. A computer implemented method for managing a distributed database system, the method comprising:
executing, by at least one processor, a dynamic structured encryption scheme including:
transforming plaintext data into a structured encryption format;
instantiating an updatable set datatype with the structured encryption format; and
executing cryptographic operations, including:
performing updates on a first party encrypted data set by the first party maintained by a second party,
performing updates on a second party encrypted data set by the second party maintained by the first party, and
executing queries on the other party's encrypted data set to return an intersection of the first party and second party encrypted data sets based on query target.

13. The method of claim 12, wherein the method comprises executing the dynamic structured encryption scheme to further include adding and removing data from an intersection data set defined on existing intersection of the first party and second party data sets.

14. The method of claim 13, wherein the method comprises executing the dynamic structured encryption scheme, wherein adding and removing include accepting as input the first party and second party encrypted data sets and outputting the union of the first party and second party encrypted data sets to both parties.

15. The method of claim 14, wherein the operations to add and remove are configured to enable set updates to vary in size or enable set updates to be malformed.

16. The method of claim 12, wherein the first party is a client system.

17. The method of claim 12, wherein the first party is a server system.

18. The method of claim 17, wherein executing the cryptographic operations includes executing oblivious pseudo random function (PRF) and two-party computation.

19. The method of claim 1, wherein executing the cryptographic operations includes executing based on symmetric-key primitives, and maintaining security to limit leakage to query equality.

20. The method of claim 12, wherein the method comprises transforming plaintext data into tree-based structure incorporating oblivious random access machine functionality (ORAM).

21. The method of claim 20, wherein the method comprises growing and shrinking a size of the tree-based structure based on operations executed in epochs.

22. The method of claim 21, wherein the method comprises updating the size of the tree-based structure based on a simulated load.
